(19) United States
(12) Patent Application Publication
(10) Pub. No.: US 2024/0360381 A1
(43) Pub. Date: Oct. 31, 2024

(54) MODIFIED ALKOXYLATED OLIGOALKYLENE IMINES AND MODIFIED ALKOXYLATED OLIGOAMINES

(71) Applicant: BASF SE, Ludwigshafen am Rhein (DE)

(72) Inventors: Holger TUERK, Ludwigshafen am Rhein (DE); Elena WOLF, Ludwigshafen am Rhein (DE); Guido VANDERMEULEN, Ludwigshafen am Rhein (DE)

(21) Appl. No.: 18/683,827

(22) PCT Filed: Aug. 17, 2022
(86) PCT No.: PCT/EP2022/072993

§ 371 Date: Feb. 15, 2024

(30) Foreign Application Priority Data
Aug. 19, 2021 (EP) 21192175.4

(51) Int. Cl. C11D 1/72; C08G 73/02

(52) U.S. Cl. CPC C11D 1/72; C08G 73/024

(57) ABSTRACT

The present invention relates to novel modified alkoxylated oligoalkylene imines and modified alkoxylated oligoamines obtainable by a process comprising the steps a) to b). According to step a), an oligoalkylene imine with a weight average molecular weight (Mw) lower than 400 g/mol or an oligoamine with a weight average molecular weight (Mw) lower than 400 g/mol as such is reacted with an alkylene oxide (AO) in order to obtain an intermediate (I). Said intermediate (I) is reacted with a lactone and/or a hydroxy carbon acid in step b) in order to obtain the novel modified alkoxylated oligoalkylene imines or modified alkoxylated oligoamines according to the present invention. The present invention further relates to a process as such for preparing such modified alkoxylated oligoalkylene imines or modified alkoxylated oligoamines as well as to the use of such compounds within, for example, cleaning compositions and/or in fabric and home care products. Furthermore, the present invention also relates to those compositions or products as such.

The present invention relates to novel modified alkoxylated oligoalkylene imines and modified alkoxylated oligoamines obtainable by a process comprising the steps a) to b). According to step a), an oligoalkylene imine with a weight average molecular weight (Mw) lower than 400 g/mol or an oligoamine with a weight average molecular weight (Mw) lower than 400 g/mol as such is reacted with an alkylene oxide (AO) in order to obtain an intermediate (I). Said intermediate (I) is reacted with a lactone and/or a hydroxy carbon acid in step b) in order to obtain the novel modified alkoxylated oligoalkylene imines or modified alkoxylated oligoamines according to the present invention. The present invention further relates to a process as such for preparing such modified alkoxylated oligoalkylene imines or modified alkoxylated oligoamines as well as to the use of such compounds within, for example, cleaning compositions and/or in fabric and home care products. Furthermore, the present invention also relates to those compositions or products as such.

Due to the climate change, one of the most important targets of the D&C industry today is to significantly lower the CO₂ emission per wash, by improving cold water conditions. Another important target of the D&C industry is the need for biodegradable polymers, to improve the sustainability of the laundry formulations and to avoid the accumulation of non-degradable polymers in the ecosystem. Although the technical hurdle is quite big to improve cold water cleaning performance, especially for the class of oily and fatty stains, amphiphilic alkoxylated polyamines, especially the ones based on polyalkylene imines like polyethylene imines (PEI), are already known in the literature to be able to contribute to oily/fatty soil removal at such conditions. However, the currently known alkoxylated polyethylene imines are not biodegradable to any significant extent, certainly not under defined conditions within 28 days as to be required by many users especially in the field of detergents, and as being a future requirement by applicable legislation in several countries and regions of the world.

WO 2015/028191 relates to water-soluble alkoxylated polyalkylene imines having an inner block of polyethylene oxide comprising 5 to 18 polyethylene oxide units, a middle block of polyalkylene oxide comprising 1 to 5 polyalkylene oxide units and an outer block of polyethylene oxide comprising 2 to 14 polyethylene oxide units. The middle block is formed from polypropylene oxide units, polybutylene oxide units and/or polypentylene oxide units. In addition, WO 2015/028191 relates to water-soluble alkoxylated polyamines. WO 2015/028191 does not disclose any alkoxylated polyalkylene imines or alkoxylated polyamines containing any substituents having fragments based on alkylene oxide, followed by a lactone and/or a hydroxy carbon acid-based fragment.

WO 2020/187648 also relates to polyalkoxylated polyalkylene imines or alkoxylated polyamines according to a general formula (I). The compounds described therein may be employed within, for example, cosmetic formulations. However, the specific compounds disclosed within WO 2020/187648 differ from the respective compounds of the present invention, since the substituents of WO 2020/187648 do not comprise any fragments based on lactones and/or hydroxy carbon acids.

GB-A 2 562 172 relates to specific functionalized polyalkylene imine polymers according to a general formula (I), which compositions are employed as pigment dispersions. GB-A 2 562 172 does not disclose any alkoxylated polyalkylene imines or alkoxylated polyamines containing any substituents having fragments based on alkylene oxide, followed by a lactone and/or a hydroxy carbon acid-based fragment.

WO 95/32272 describes ethoxylated and/or propoxylated polyalkylene amine polymers to boost soil dispersing performance, wherein said polymers have an average degree of ethoxylation/propoxylation of from 0.5 to 10 per nitrogen.

EP-A 0 759 440 discloses a dispersing agent for solids based on the phosphonation at the end groups of compounds such as a polyurethane. A polyurethane as such is obtained by the reaction of an amine with an alkylene oxide or an alkylene carbonate, wherein 50 to 100% of the NH-functionalities of the respective amine are oxylated. Afterwards, the respective intermediate (aminoalcohol) is again reacted with a hydroxy carboxylic acid or a diacid and a diol in order to obtain a polyester, or a respective reaction with a diisocyanate is carried out in order to obtain such a polyurethane. The various individual intermediates of the second reaction step are phosphonated within a last reaction step afterwards. By consequence, EP-A 0 759 440 does not disclose any modified alkoxylated oligoalkylene imines or alkoxylated oligoamines according to the present invention obtainable by a process comprising the steps a) to b) as defined below.

WO 2020/83680 discloses esterified polyalkyleneimine polyalkoxylates, their use to increase the primary washing and cleaning power of detergents and cleaning agents containing such polyalkyleneimine derivatives. The polymers can be obtained by reacting polyalkoxylated polyalkyleneimines with hydroxyl- or aminoalkylcarboxylic acids and/or reactive hydroxyl- or aminoalkylcarboxylic acid derivatives. The compounds can be used for improved fatty/oily soil removal in laundry and cleaning of hard surfaces. A further use of those compounds to improve the removal of other soils, e.g., particulate soils, in combination with fatty/oily soil removal, is not disclosed. WO 2020/83680 also does not disclose alkoxylated oligoalkylene imines or alkoxylated oligoamines as such with a weight average molecular weight (Mw) lower than 400 g/mol.

The object of the present invention is to provide novel compounds based on an oligoalkylene imine backbone with a weight average molecular weight (Mw) lower than 400 g/mol or an oligoamine backbone with a weight average molecular weight (Mw) lower than 400 g/mol. Furthermore, those novel compounds should have beneficial properties when being employed within compositions in respect of their biodegradability.

The object is achieved by a modified alkoxylated oligoalkylene imine or modified alkoxylated oligoamine obtainable by a process comprising the steps a) to b) as follows:
a) reaction of i) at least one oligoalkylene imine with a weight average molecular weight (Mw) lower than 400 g/mol or at least one oligoamine with a weight average molecular weight (Mw) lower than 400 g/mol with ii) at least one alkylene oxide (AO), wherein at least 10 mol of alkylene oxide (AO) is employed per mol of NH-functionality of oligoalkylene imine or of oligoamine, in order to obtain an intermediate (I),
b) reaction of the intermediate (I) with at least one lactone (LA) and/or at least one hydroxy carbon acid (HA), wherein at least 1.0 mol of lacton (LA) and/or hydroxy carbon acid (HA) is employed per mol of NH-functionality of oligoalkylene imine or of oligoamine (as employed in step a)), in order to obtain the modified alkoxylated oligoalkylene imine or the modified alkoxylated oligoamine.

The modified alkoxylated compounds according to the present invention may be used in cleaning compositions. They lead to at least comparable and preferably even improved cleaning performance of said composition, for example in respect of removing fat and/or oil, compared to corresponding alkoxylated compounds according to the prior art. Beyond that, it has surprisingly been found that the modified alkoxylated compounds according to the present invention lead to an improved biodegradability when being employed within compositions, for example, within cleaning compositions. Improved cleaning performance and/or improved biodegradability is especially found for modified alkoxylated oligoalkylene imines or modified alkoxylated oligoamines with weight average molecular weights (Mw) lower than 400 g/mol of the backbone.

An advantage of the modified alkoxylated compounds according to the present invention can be seen in their amphiphilic properties, especially due to the employment of a high amount of alkylene oxides, especially of hydrophilic ethylene oxide, within step a) of the inventive process, in combination with the formation of a hydrophobic block based on lactones or hydroxy carbon acids, within step b) of the inventive process. The compounds of the present invention combine good biodegradability properties, due to the ester bonds in the hydrophobic block, with excellent cleaning properties in detergent applications, due to their amphiphilic nature.

Another advantage can be seen within the respective detergent formulations containing the inventive compounds, for example, in liquid and solid (powder) formulations containing at least one surfactant and the inventive compound, preferably with focus on laundry formulations and manual dish wash formulations with main focus on liquid laundry and liquid manual dish wash formulations, and with very specifically focus on liquid laundry formulations and single mono doses for laundry, containing at least one anionic surfactant, water and the inventive compound.

For the purpose of the present invention, the expression/term “modified” relates to the presence of (predominately) hydrophobic polyester blocks based on lactones or hydroxyl carbon acids within the inventive modified alkoxylated oligoalkylene imines or the modified alkoxylated oligoamines (obtainable by a process comprising the steps a) to b)), due to carrying out step b). Expressed in other words, this means that the (alkoxylated) intermediates obtained in step a) (due to the alkoxylation of the employed oligoalkylene imines or oligoamines (backbone)) are further reacted/modified within step b) with at least one lactone (LA) and/or at least one hydroxy carbon acid (HA) in order to obtain the modification desired. By consequence, at the periphery of several residues, such as residues according to formula (IIa) expressed by the variables R³ and m, fragments with (predominately) hydrophobic polyester blocks are obtained. Those fragments with (predominately) hydrophobic polyester blocks lead to the amphiphilic nature and thus to excellent cleaning properties of the inventive polymers in detergent applications.

The term “polymer”, “polymer of the invention” or “inventive polymer”, as used herein, refers to modified alkoxylated (oligo-)polyalkylene imines as described below and/or in the appended claims.

For the purposes of the present invention, definitions such as C₁-C₂₂-alkyl, as defined below for, for example, the radical R² in formula (IIa), mean that this substituent (radical) is an alkyl radical having from 1 to 22 carbon atoms. The alkyl radical can be either linear or branched or optionally cyclic. Alkyl radicals which have both a cyclic component and a linear component likewise come within this definition. The same applies to other alkyl radicals such as a C₁-C₄-alkyl radical. Examples of alkyl radicals are methyl, ethyl, n-propyl, sec-propyl, n-butyl, sec-butyl, isobutyl, 2-ethylhexyl, tert-butyl (tert-Bu/t-Bu), pentyl, hexyl, heptyl, cyclohexyl, octyl, nonyl, decyl or dodecyl.

The term “C₂-C₂₂-alkylene” as used herein refers to a saturated, divalent straight chain or branched hydrocarbon chains of 2, 3, 4, 5, 6, 10, 12 or up to 22 carbon atoms, examples including ethane-1,2-diyl (“ethylene”), propane-1,3-diyl, propane-1,2-diyl, 2-methylpropane-1,2-diyl, 2,2-dimethylpropane-1,3-diyl, butane-1,4-diyl, butane-1,3-diyl (═1-methylpropane-1,3-diyl), butane-1,2-diyl (“1,2-butylene”), butane-2,3-diyl, 2-methyl-butan-1,3-diyl, 3-methyl-butan-1,3-diyl (═1,1-dimethylpropane-1,3-diyl), pentane-1,4-diyl, pentane-1,5-diyl, pentane-2,5-diyl, 2-methylpentane-2,5-diyl (═1,1-dimethylbutane-1,3-diyl) and hexane-1,6-diyl.

The term “C₅-C₁₀-cycloalkylene” as used herein refers to saturated, divalent hydrocarbons of 5, 6, 7, 8, 9 or 10 carbon atoms wherein all or at least a part of the respective number of carbon atoms form a cycle (ring). In case not all of the respective number of carbon atoms form a cycle, such remaining carbon atoms (i.e., those carbon atoms not forming a cycle) form a methane-1,1-diyl (“methylene”) fragment or an ethane-1,2-diyl (“ethylene”) fragment of the respective C₅-C₁₀-cycloalkylene radicals. One of the two valencies of said respective methylene or ethylene fragments is bound to a neighbouring nitrogen atom within general formula (I), whereas the second valency of said fragments is bound to the cyclic fragment of said C₅-C₁₀-cycloalkylene radical.

Expressed in other words, a C₅-C₁₀-cycloalkylene radical may comprise, in addition to its cyclic fragment, also some non-cyclic fragments building a bridge or a linker of the cyclic fragment of the C₅-C₁₀-cycloalkylene radical to the neighbouring nitrogen atom within general formula (I). The number of such carbon linker atoms is usually not more than 3, preferably 1 or 2. For example, a C₇-cycloalkylene radical may contain one C₆-cycle and one C₁-linker.

The respective hydrocarbon cycle itself may be unsubstituted or at least monosubstituted by C₁-C₃-alkyl. It has to be noted that the carbon atoms of the respective C₁-C₃-alkyl substituents are not considered for determination of the number of carbon atoms of the C₅-C₁₀-cycloalkylene radical. In contrast to that, the number of carbon atoms of such a C₅-C₁₀-cycloalkylene radical is solely determined without any substituents, but only by the number of carbon atoms of the cyclic fragment and optionally present carbon linker atoms (methylene or ethylene fragments).

Examples for C₅-C₁₀-cycloalkylene include cyclopentane-1,2-diyl, cyclohexane-1,2-diyl, cyclohexane-1,3-diyl, cyclohexane-1,4-diyl, 3-(methane-1,1-diyl)-cyclohexane-1,3-diyl, cycloheptane-1,3-diyl or cyclooctane-1,4-diyl, each of the aforementioned radicals may be at least monosubstituted with C₁-C₃-alkyl.

It is preferred that the respective C₅-C₁₀-cycloalkylene radical is employed as a mixture of two or more individual cycloalkylene radicals having the same ring size. It is particularly preferred to employ a mixture of cyclohexane-1,3-diyl monosubstituted with methyl in position 2 or 4, respectively, of the cycle. The ratio of the two compounds is preferably in a range of 95:5 to 75:25, most preferably about 85:15 (4-methyl versus 2-methyl).

3-(methane-1,1-diyl)-cyclohexane-1,3-diyl is a preferred example for a C₅-C₁₀-cyclo-alkylene radical having a non-cyclic fragment in addition to its cyclic fragment. For this specific case, the non-cyclic fragment is a C₁-linker and the cyclic fragment is a C₆-cycle resulting in a C₇-cycloalkylene radical. 3-(methane-1,1-diyl)-cyclohexane-1,3-diyl may also be substituted with at least one C₁-C₃-alkyl, preferably with three methyl groups, in particular 3,5,5-trimethyl. The latter one is a fragment of isophorone diamine, which may be employed as backbone with general formula (I).

For the purposes of the present invention, the term “aralkyl” or “C₇-C₂₂-aralkyl”, respectively, as defined below for, for example, the radical R² in formula (IIa), means that the substituent (radical) is an aromatic (“ar”) combined with an alkyl substituent (“alkyl”). The aromatic “ar” part can be a monocyclic, bicyclic or optionally polycyclic aromatic. In the case of polycyclic aromatics, individual rings can optionally be fully or partially saturated. Preferred examples of aryl are phenyl, naphthyl or anthracyl, in particular phenyl. The sum of the carbon atoms of the aromatic and the alkyl fragment is a radical having from 7 to 22 carbon atoms

The term “—(CO)—C₁-C₂₂-alkyl” as used hereinafter, for example, within the definition for the radical R² in formula (IIa) means that this substituent contains a carbonyl group (CO) bound to an alkyl radical having 1 to 22 carbon atoms as defined above. The alkyl radical can be either linear or branched or optionally cyclic. Alkyl radicals which have both a cyclic component and a linear component likewise come within this definition. The same applies to the definitions of the term “—(CO)—C₇-C₂₂-aralkyl” in respect of a carbonyl group (CO) bound to a radical having an aromatic and an alkyl fragment with a sum of 7 to 22 carbon atoms as defined above.

For the purposes of the present invention, definitions such as C₂-C₃₀-alkenyl, as defined below, for example, as part of the term “—(CO)—C₂-C₃₀-alkenyl” of the radical R² in formula (IIa), mean that this part of the substituent (radical) is an alkenyl radical having from 2 to 30 carbon atoms. This carbon radical is preferably monounsaturated but can optionally also be doubly unsaturated or multiply unsaturated. As regards linearity, branches and cyclic constituents, what has been said above for C₁-C₃₀-alkyl radicals applies analogously. C₂-C₃₀-alkenyl is, for the purposes of the present invention, preferably vinyl, 1-allyl, 3-allyl, 2-allyl, cis- or trans-2-butenyl, ω-butenyl. The term “—(CO)—C₂-C₃₀-alkenyl” in turn relates to a substituent containing a carbonyl group (CO) bound to such an alkenyl radical having from 2 to 30 carbon atoms as defined above.

The term “unsubstituted or at least monosubstituted C₁-C₂₂-alkyl, C₇-C₂₂-aralkyl, —(CO)—C₁-C₂₂-alkyl, —(CO)—C₂-C₃₀-alkenyl and/or —(CO)—C₇-C₂₂-aralkyl” as defined below, for example, in R² in formula (IIa) means that each of the mentioned/listed radicals (substituents) such as C₁-C₂₂-alkyl or —(CO)—C₇-C₂₂-aralkyl may either be unsubstituted or at least monosubstituted with the specific substituents as defined in the (following) context. For the sake of completeness it is also indicated that a person skilled in the art knows that the mentioned substituents replace a hydrogen atom of the respective radicals (substituents) such as C₁-C₂₂-alkyl or —(CO)—C₇-C₂₂-aralkyl. In case the substituents are selected from —COOH or a salt thereof, the respective salts are known to the skilled person. Preferably, the salts are selected from alkali salts such as sodium or potassium salts, in particular a sodium salt (—COONa).

Within the context of the present invention, the terms “oligoalkylene imine” and “oligoamine” differ from the corresponding terms “polyalkylene imine” and “polyamine” in respect of the weight average molecular weight (Mw) of the compounds as such as employed within step a) as educt or within the backbone of the corresponding modified alkoxylated compounds as such as obtained within step b) of the inventive process. Whereas “oligoalkylene imines” and “oligoamines” in the context of the present invention have a weight average molecular weight (Mw) of below 400 g/mol (in respect of their backbone without consideration of any alkoxylation), the corresponding “polyalkylene imines” and “polyamines”, according to the present invention, have a weight average molecular weight (Mw) of 400 g/mol or higher (in respect of their backbone without consideration of any alkoxylation).

Furthermore, within the context of the present invention, the term “oligoalkylene imine” differs from the corresponding term “oligoamine” especially in respect of the branching of the compounds as such as employed within step a) as educt or within the backbone of the corresponding modified alkoxylated compounds as such as obtained within step b) of the inventive process. Whereas oligoamines in the context of the present invention are (predominantly) linear compounds (in respect of its backbone without consideration of any alkoxylation), containing primary and/or secondary amino moieties but no tertiary amino moieties within its backbone, the corresponding oligoalkylene imines are, according to the present invention, (predominantly) branched molecules containing (in respect of its backbone without consideration of any alkoxylation), in addition to the primary and/or secondary amino moieties, mandatorily tertiary amino moieties, which cause the branching of the (linear) main chain into several side chains within the oligomeric backbone (basic skeleton). Oligoalkylene imines, both as backbone and as modified alkoxylated compounds, are thus compounds falling under the definition of general formula (I), wherein z is an integer of at least 1 and/or y is an integer of at least one and at least one of the variables (residues) E¹ is C₁-C₁₈-alkyl. In contrast to that, oligoamines, both as backbone and as modified alkoxylated compounds, are those compounds of formula (I), wherein z is 0 and E¹ is hydrogen, or wherein both z and y are 0.

By consequence, the inventive modified alkoxylated oligoalkylene imines with a weight average molecular weight (Mw) of below 400 g/mol and the modified alkoxylated oligoamines with a weight average molecular weight (Mw) of below 400 g/mol have a basic skeleton (backbone), wherein the basic skeleton (backbone) comprises primary, secondary and/or tertiary amine nitrogen atoms which are joined by alkylene radicals R (as defined below) and are in the form of the following moieties in random arrangement:
primary amino moieties which terminate the main chain and the side chains of the basic skeleton and whose hydrogen atoms are subsequently replaced by alkylenoxy units:

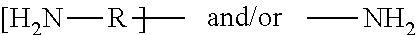

secondary amino moieties whose hydrogen atom is subsequently replaced by alkylenoxy units:

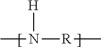

tertiary amino moieties which branch the main chain and the side chains:

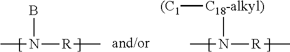

For the sake of completeness, it is indicated that the variable B indicating the branching of the oligoalkylene imine backbone of compounds according to general formula (I) contains at least one fragment with at least one further amino moiety such as —[—NE¹—R]_{y}, H₂N—R or combinations thereof, including a two times, three times or even higher degree of branching. It has to be noted that the variable E¹ with C₁-C₁₈-alkyl also provides a branching of the respective backbone and, by consequence, another type of tertiary amino moiety, but in contrast to the definition of the variable B, the variable E¹ does not contain any further amino moiety. However, none of the tertiary amino moieties are present in the backbone of oligoamine compounds. The degree of branching may be determined, for example, by NMR-spectroscopy such as ¹H-NMR or preferably ¹³C-NMR.

In order to obtain the respective (modified) alkoxylated compounds according to the present invention, the hydrogen atoms of the primary and/or secondary amino groups of the basic oligoalkylene imine or oligoamine skeleton are replaced by substituents such as those according to the formula (IIa) as defined below.

Within the context of the present invention, the term “oligoalkylene imine backbone” relates to those fragments of the inventive modified alkoxylated oligoalkylene imines which are not alkoxylated and not further modified. The oligoalkylene imine backbone is employed within the present invention as an educt in step a) to be reacted first with at least one alkylene oxide (AO), followed by reaction (in step b)) with at least one lactone or hydroxy carbon acid in order to obtain the inventive modified alkoxylated oligoalkylene imines. Oligoalkylene imines as such (backbones or not alkoxylated compounds) are known to a person skilled in the art.

Within the context of the present invention, the term “oligoamine backbone” relates to those fragments of the inventive modified alkoxylated oligoamines which are not alkoxylated and not further modified. The oligoamine backbone is employed within the present invention as an educt in step a) to be reacted first with at least one alkylene oxide (AO), followed by reaction (in step b)) with at least one lactone or hydroxy carbon acid in order to obtain the inventive modified alkoxylated oligoamines. Oligoamines as such (backbones or not alkoxylated compounds) are known to a person skilled in the art.

Within the context of the present invention, the term “NH-functionality” is defined as follows: In case of defined organic amines, such as di- and oligo amines like BAPMA, N4-amine or 1,6-hexamethylene diamine, the structure itself gives information about the content of primary, secondary and tertiary amines. A primary amino group (—NH₂) has two NH-functionalities, a secondary amino group only one NH functionality, and a tertiary amino group, by consequence, has no reactive NH functionality. In case of linear and branched oligomerization products, such as those as described above, the respective oligomer may contain a mixture of primary and secondary and tertiary amino groups. The exact distribution of primary, secondary and tertiary amino groups can be determined as described in Lukovkin G. M., Pshezhetsky V. S., Murtazaeva G. A.: Europ. Polymer Journal 1973, 9, 559-565 and St. Pierre T., Geckle M.: ACS Polym. Prep. 1981, 22, 128-129, or by determination of the primary, secondary and tertiary amino number, according to DIN 16945. In case of the modification with lactone or hydroxy carbon acids and alkylene oxides, this information is then used to calculate the total amount of NH functionalities in the oligoalkylene imine, which serves as the basis for the amount of modification reagents to be employed in the reaction.

For the purpose of the present invention, the term “integer”—as defined, for example, for the number of the different repeating units such as the variables m or n of the residue according to general formula (IIa)—relates to the average number of each of the different repeating units of that specific residue, i.e., to the number of each of the different repeating units of the most frequent residue among all existing specific residues according to general formula (IIa), as obtained by the respective synthesis/polymerization conditions. It is clear to the person skilled in the art that a polymer composition usually contains a statistically distributed mixture of individual polymers or a statistically distributed mixture of individual residues according to, for example, general formula (IIa), respectively. It is therefore clear to a person skilled in the art that within such a statistically distributed mixture of individual residues according to general formula (IIa) the individual residues as such may differ in respect of the numbers of said repeating units. The same holds true for any other specific residue according to the present invention such as the residues according to general formulas (IIb) or (IIc). The average number of repeating units can be determined by analytical methods such as NMR and GPC. Preferably, within the embodiment of the present invention, the determination of the average number of repeating units, such as the variables m or n in the residue according to general formula (IIa), is performed by closely monitoring the conversion rates of each of the synthetical steps a)-b) using ¹³C-NMR-spectroscopy and/or ¹H-NMR-spectroscopy

The invention is specified in more detail as follows:

The invention relates to a modified alkoxylated oligoalkylene imine or modified alkoxylated oligoamine obtainable by a process comprising the steps a) to b) as follows:
a) reaction of i) at least one oligoalkylene imine with a weight average molecular weight (Mw) lower than 400 g/mol or at least one oligoamine with a weight average molecular weight (Mw) lower than 400 g/mol with ii) at least one alkylene oxide (AO), wherein at least 10 mol of alkylene oxide (AO) is employed per mol of NH-functionality of oligoalkylene imine or of oligoamine, in order to obtain an intermediate (I),
b) reaction of the intermediate (I) with at least one lactone (LA) and/or at least one hydroxy carbon acid (HA), wherein at least 1.0 mol of lactone (LA) and/or hydroxy carbon acid (HA) is employed per mol of NH-functionality of oligoalkylene imine or of oligoamine (as employed in step a)), in order to obtain the modified alkoxylated oligoalkylene imine or the modified alkoxylated oligoamine.

In step a), it is possible that the complete amount of the at least one alkylene oxide (AO) is added at once, but it is also possible that portions of the at least one alkylene oxide (AO) are added batchwise, in two or more batches.

The oligoalkylene imine with a weight average molecular weight (Mw) lower than 400 g/mol or the oligoamine with a weight average molecular weight (Mw) lower than 400 g/mol employed in step a) may be any compound known to a person skilled in the art.

Examples of oligoalkylene imines with a weight average molecular weight (Mw) lower than 400 g/mol are defined N-Alkyl-substituted organic amines like N,N-Bis-(3-aminopropyl)methylamine (abbreviated as “BAPMA”) and oligomerization products comprising such amines as monomers, as described in WO 2017009220, with weight average molecular weight of below 400 g/mol. For the sake of completeness, it is indicated that the term oligoalkylene imines with a weight average molecular weight (Mw) lower than 400 g/mol also comprises imines with only one (tertiary) amino moiety, in addition to the two terminal primary amino moieties, as described above. Therefore, the term oligoalkylene imines with a weight average molecular weight (Mw) lower than 400 g/mol comprises imines with at least three amino moieties.

Examples of oligoamines with a weight average molecular weight (Mw) lower than 400 g/mol are defined organic amines like 1,2-ethylene diamine (EDA), 1,3-propylene diamine (PDA), 1,6-hexamethylene diamine (HMDA), N,N′-Bis-(3-aminopropyl)-ethylenediamine (N4-amine), oligomers of ethylene imine like diethylene triamine (DETA), triethylene tetramine (TETA) and tetraethylene pentamine (TEPA), oligomers of propylene imine like dipropylene triamine (DPTA), tripropylene tetramine (TPTA) and tetrapropylene pentamine (TPPA), and oligomerization products comprising such amines as monomers, as described in EP 2961819 B1 and WO2014131649A1, with weight average molecular weight of below 400 g/mol. For the sake of completeness, it is indicated that the term oligoamines with a weight average molecular weight (Mw) lower than 400 g/mol also comprises amines with only two primary amino moieties and no further secondary moieties, as described above. Therefore, the term oligoamines with a weight average molecular weight (Mw) lower than 400 g/mol comprises amines with at least two amino moieties.

It is preferred that the at least one oligoalkylene imine with a weight average molecular weight (Mw) lower than 400 g/mol or the oligoamine with a weight average molecular weight (Mw) lower than 400 g/mol as employed in step a) is defined according to general formula (I)

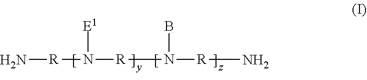

in which the variables are each defined as follows:
R represents identical or different,
   i) linear or branched C₂-C₁₂-alkylene radicals or
   ii) an etheralkyl unit of the following formula (III):

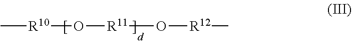

In which the variables are each defined as follows:
R¹⁰, R¹¹, R¹² represent identical or different, linear or branched C₂-C₆-alkylene radicals and
d is an integer having a value in the range of 0 to 6 or
iii) C₅-C₁₀ cycloalkylene radicals optionally substituted with at least one C₁-C₃ alkyl;
y is an integer having a value in the range of 0 to 8.
E¹ represents identical or different
i) hydrogen or
ii) hydrogen and/or C₁-C₁₈-alkyl;
B represents a continuation of the oligoalkylene imine by branching;
z is an integer having a value in the range of 0 to 8;
the sum of y+z is an integer having a value in the range of 0 to 8, preferably in the range of 0 to 7;
preferably, R represents identical or different,
i) linear or branched C₂-C₁₂-alkylene radicals, more preferably R is ethylene, propylene or hexamethylene, or
ii) C₅-C₁₀-cycloalkylene radicals optionally substituted with at least one C₁-C₃-alkyl, more preferably R is at least one C₆-C₇-cycloalkylene radical substituted with at least one methyl or ethyl;
preferably, E¹ represents H and/or methyl;
more preferably, E¹ represents H.

For the sake of completeness, it is indicated that the variable B indicating the branching of the oligoalkylene imine compounds according to general formula (I) contains at least one fragment with at least one further amino moiety such as —[—NE¹—R]_{y}, H₂N—R or combinations thereof, including a two times, three times or even higher degree of branching. It has to be noted that the variable E¹ with C₁-C₁₈-alkyl also provides a branching of the respective backbone and, by consequence, (another type) of a tertiary amino moiety, but in contrast to the definition of the variable B, the variable E¹ does not contain any further amino moiety. However, none of the mentioned tertiary amino moieties are present within oligoamine compounds according to general formula (I)).

In one preferred embodiment of the invention, the weight average molecular weight (Mw) of the oligoalkylene imine or of the oligoamine employed in step a) lies in the range of 60 to 390 g/mol, preferably in the range of 60 to 360 g/mol.

In another preferred embodiment of the present invention, the weight average molecular weight (Mw) of the oligoalkylene imine or the oligoamine employed in step a) lies in the range of 100 to 200 g/mol.

In another preferred embodiment of the present invention, the weight average molecular weight (Mw) of the oligoalkylene imine or the oligoamine employed in step a) lies in the range of 250 to 350 g/mol.

For the sake of completeness, it is indicated that the weight average molecular weight (Mw) is identical to the number average moleculer weight (Mn) in case that defined polyalkylene imines and polyamines such as BAPMA and HMDA (single compounds) are employed as starting materials in step a) of the inventive process. Therefore, Mw and Mn are identical to their molar mass.

In a preferred embodiment of the present invention, the modified alkoxylated oligoalkylene imine or modified alkoxylated oligoamine contains at least one residue according to general formula (IIa)

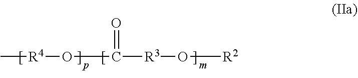

in which the variables are each defined as follows:
R² is hydrogen or selected from the group of unsubstituted or at least monosubstituted C₁-C₂₂-alkyl, C₇-C₂₂-aralkyl, —(CO)—C₁-C₂₂-alkyl, —(CO)—C₂-C₃₀-alkenyl and/or —(CO)—C₇-C₂₂-aralkyl and the substituents are selected from —COOH or a salt thereof;
R³ represents linear or branched C₁-C₂₂-alkylene radicals;
R⁴ represents C₂-C₂₂-(1,2-alkylene) radicals;
m is an integer having a value of at least 1 to 20;
p is an integer having a value of at least 10 to 100;
preferably the variables within general formula (IIa) are defined as follows:
R² represents hydrogen, C₁-C₄-alkyl, —(CO)—C₁-C₄-alkyl, more preferably hydrogen, methyl, ethyl or —(CO)—C₁-C₂-alkyl, most preferably hydrogen; and/or
R³ represents linear or branched C₂-C₁₀-alkylene radicals, more preferably linear or branched C₂-C₅-alkylene radicals; and/or
R⁴ represents 1,2-ethylene and/or 1,2-propylene, more preferably 1,2-ethylene; and/or
m is an integer having a value in the range of 1 to 15, more preferably of 1 to 10, most preferably 2 to 10; and/or
p is an integer having a value in the range of 10 to 50, more preferably of 15 to 40, most preferably 20 to 35.

In another embodiment of the present invention, it is preferred that in addition to the presence of at least one residue according to general formula (IIa) as described above, the modified alkoxylated oligoalkylene imine or alkoxylated oligoamine contains at least one residue according to general formula (IIb)

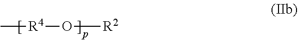

in which the variables are defined as follows:
R² is hydrogen or selected from the group of unsubstituted or at least monosubstituted C₁-C₂₂-alkyl, C₇-C₂₂-aralkyl, —(CO)—C₁-C₂₂-alkyl, —(CO)—C₂-C₃₀-alkenyl and/or —(CO)—C₇-C₂₂-aralkyl and the substituents are selected from —COOH or a salt thereof;
R⁴ represents C₂-C₂₂-(1,2-alkylene) radicals;
   p is an integer having a value of at least 10 to 100;
preferably the variables within general formula (IIb) are defined as follows:
R² represents hydrogen, C₁-C₄-alkyl, —(CO)—C₁-C₄-alkyl, preferably hydrogen, methyl, ethyl or —(CO)—C₁-C₂-alkyl, most preferably hydrogen; and/or
R⁴ represents 1,2-ethylene and/or 1,2-propylene, more preferably 1,2-ethylene; and/or
p is an integer having a value in the range of 10 to 50, more preferably of 15 to 40, most preferably 20 to 35.

In another embodiment of the present invention, it is preferred that
i) step a) is carried out in the absence of water and/or in the presence of a catalyst, and/or
ii) step a) is carried out as a two-step reaction, wherein the first step is carried out in the presence of water and the second step is carried out without any water, but in the presence of a catalyst, and/or
iii) more than 50 wt.-% of the alkylene oxide (AO) employed in step a) is based on ethylene oxide, and/or
iv) the weight average molecular weight (Mw) of the oligoalkylene imine or of the oligoamine employed in step a) lies in the range of 60 to 390 g/mol, preferably in the range of 60 to 360 g/mol; or
v) the weight average molecular weight (Mw) of the oligoalkylene imine or the oligoamine employed in step a) lies in the range of 100 to 200 g/mol; or
vi) the weight average molecular weight (Mw) of the oligoalkylene imine or the oligoamine employed in step a) lies in the range of 250 to 350 g/mol.

The person skilled in the art knows how to determine/measure the respective weight average molecular weight (M_{w}). This can be done, for example, by size exclusion chromatography (such as GPC, e.g., in combination with light scattering). Preferably, M_{w} values are determined by the method as follows: OECD TG 118 (1996), which means in detail

OECD (1996), Test No. 118: Determination of the Number-Average Molecular Weight and the Molecular Weight Distribution of Polymers using Gel Permeation Chromatography, OECD Guidelines for the Testing of Chemicals, Section 1, OECD Publishing, Paris, also available on the internet, for example, under https://doi.org/10.1787/9789264069848-en.

Molecular weights of the polyamine starting materials may be determined by gel permeation chromatography (GPC). The measurements may be carried out on a combination of the following three columns: HFIP-LG Guard, PL HFIPGEL and PL HFIPGel. Elution may be performed at a constant flow rate of 1 mL/min with Hexafluoroisopropanol and 0.05 wt % Potassium trifluroroacetate. The injected sample may be prefiltered over a Millipore Millex FG (0.2 μm), 50 μL may be injected with a concentration of 1.5 mg/mL (diluted in eluent). The effluent may be monitored by the UV detector DRI Agilent 1100 at λ=230 and 280 nm. The calibration may be carried out using PMMA standards (PSS, Mainz, Germany) with a molecular weight from 800 to 2 200 000 g/mol. Values outside of the calibration range may be extrapolated.

Molecular weights of the modified alkoxylated oligoalkylene imines and modified alkoxylated oligoamines may be determined by gel permeation chromatography (GPC).

The measurements may be carried on a combination of two columns (styrene-divinylbenzene and polyester copolymer, both 25 cm in length), using 0.05 wt % Potassium trifluoroacetate in Hexafluoroisopropanol as eluent. The molecular weights may be obtained by using an RI detector and PEO standards (Polymer Laboratories/Agilent, USA) for calibration. In addition, the absolute molar mass may be determined by multi angle light scattering (MALLS).

Another embodiment of the present invention relates to modified alkoxylated oligoalkylene imines (as such) as described above, it is preferred that the variables are each defined as follows:
R is ethylene and/or propylene, preferably ethylene;
the sum of y+z is an integer having a value in the range of 1 to 8, preferably in the range of 1 to 7.

Another embodiment of the present invention relates to modified alkoxylated oligoalkylene imines (as such) or modified alkoxylated oligoamines (as such) as described above, it is preferred that the variables are each defined as follows:
y is an integer having a value in the range of 0 to 8, preferably in the range of 0 to 7;
z is 0;
E¹ represents H and/or methyl;
R represents identical or different, linear or branched C₂-C₁₂-alkylene radicals or an etheralkyl unit according to formula (III), wherein
   d is from 0 to 6, and
   R¹⁰, R¹¹, R¹² are independently selected from linear or branched C₃ to C₄ alkylene radicals;
   preferably, R represents identical or different, linear C₂ and/or C₃-alkylene radicals.

In another embodiment of the present invention, it is preferred that
i) in step a) the alkylene oxide (AO) is at least one C₂-C₂₂-epoxide, preferably ethylene oxide and/or propylene oxide, more preferably ethylene oxide, and/or
ii) in step b) the lactone (LA) is caprolactone or lactide, and/or
iii) in step b) the hydroxy carbon acid (HA) is lactic acid or glycolic acid.

In another embodiment of the present invention, it is preferred that
i) in step a) 10 to 100 mol, preferably 10 to 50 mol, more preferably 15 to 40 mol, most preferably 20 to 35 mol of alkylene oxide (AO) is employed per mol of NH-functionality of oligoalkylene imine or of oligoamine, and/or
ii) in step b) 1.0 to 10 mol, preferably 1.0 to 6.0 mol, more preferably 2.0 to 4.0 mol of lactone (LA) and/or 1.0 to 20 mol, preferably 2.0 to 15 mol, more preferably 3.0 to 10 mol of hydroxy carbon acid (HA) is employed per mol of NH-functionality of oligoalkylene imine or of oligoamine (as employed in step a)).

In another embodiment of the present invention, it is preferred that
i) in step a) the alkylene oxide (AO) is ethylene oxide.

ii) in step a) 10 to 100 mol, preferably 10 to 50 mol, more preferably 15 to 40 mol, most preferably 20 to 35 mol of alkylene oxide (AO) is employed per mol of NH-functionality of oligoalkylene imine or of oligoamine, and/or
iii) in step b) the lactone is caprolactone, and 1.0 to 10 mol, preferably 1.0 to 6.0 mol, more preferably 2.0 to 4.0 mol of caprolactone is employed per mol of NH-functionality of oligoalkylene imine or of oligoamine (as employed in step a)).

In another embodiment of the present invention, it is preferred thatup to 100% of the nitrogen atoms present in the modified alkoxylated oligoalkylene imine or modified alkoxylated oligoamine are further quaternized, preferably the degree of quaternization of the nitrogen atoms present in the modified alkoxylated oligoalkylene imine or modified alkoxylated oligoamine lies in the range of 10% to 95%.

As mentioned above, the inventive modified alkoxylated oligoalkylene imines or alkoxylated oligoamines may also be quaternized. A suitable degree of quaternization is up to 100%, in particular from 10 to 95%. The quaternization is conducted preferably by introducing C₁-C₂₂-alkyl groups, C₁-C₄-alkyl groups and/or C₇-C₂₂-aralkyl groups and may be undertaken in a customary manner by reaction with corresponding alkyl halides and dialkyl sulfates.

The quaternization may be advantageous in order to adjust the modified alkoxylated oligoalkylene imines or the alkoxylated oligoamines to the particular composition such as laundry compositions in which they are to be used, and to achieve better compatibility and/or phase stability of the formulation.

The quaternization of modified alkoxylated oligoalkylene imines or alkoxylated oligoamines is achieved preferably by introducing C₁-C₂₂ alkyl, C₁-C₄-alkyl groups and/or C₇-C₂₂ aralkyl, aryl or alkylaryl groups and may be undertaken in a customary manner by reaction with corresponding alkyl, aralkyl-halides and dialkylsulfates, as described for example in WO 09/060059.

Quaternization can be accomplished, for example, by reacting an alkoxylated oligoamines or a modified alkoxylated oligoalkylene imine with an alkylation agent such as a C₁-C₄-alkyl halide, for example with methyl bromide, methyl chloride, ethyl chloride, methyl iodide, n-butyl bromide, isopropyl bromide, or with an aralkyl halide, for example with benzyl chloride, benzyl bromide or with a di-C₁-C₂₂-alkyl sulfate in the presence of a base, especially with dimethyl sulfate or with diethyl sulfate. Suitable bases are, for example, sodium hydroxide and potassium hydroxide.

The amount of alkylating agent determines the amount of quaternization of the amino groups in the oligomer, i.e. the amount of quaternized moieties.

The amount of the quaternized moieties can be calculated from the difference of the amine number in the non-quaternized amine and the quaternized amine.

The amine number can be determined according to the method described in DIN 16945.

The quaternization can be carried out without any solvent. However, a solvent or diluent like water, acetonitrile, dimethylsulfoxide, N-methylpyrrolidone, etc. may be used. The reaction temperature is usually in the range from 10° C. to 150° C. and is preferably from 50° C. to 100° C.

Another subject of the present invention is a process for preparing the modified alkoxylated oligoalkylene imines or the alkoxylated oligoamines as described above. In the following the steps a) to b) (as described above) are described in more detail. The below information also applies to the above described polymer as such, obtainable by the respective process. Within this process, a oligoalkylene imine (as such) with a weight average molecular weight (Mw) of less than 400 g/mol or a oligoamine (as such) with a weight average molecular weight (Mw) of less than 400 g/mol is according to step a) first reacted with at least one alkylene oxide (AO), followed in step b) by reaction of the respective intermediate (I) with at least one lactone and/or at least one hydroxy carbon acid in order to obtain the respective modified alkoxylated compounds. In case two or more alkylene oxides are employed in step a), the respective alkoxylated compounds may contain either a random orientation of the respective alkylene oxide fragments or a block orientation. It is furthermore preferred that, in case two or more alkylene oxides are employed in step a), more than 50 wt.-% of the employed AO is ethylene oxide (EO).

The conversion rate of each of the respective steps can be determined according to methods known to the skilled person, such as NMR-spectroscopy. For example, both the first reaction step and the second reaction step may be monitored by ¹³C-NMR-spectroscopy and/or ¹H-NMR-spectroscopy. As described above, the first reaction step (step a)) of the method according to the present invention as such (alkoxylation, in particular ethoxylation) is known to a person skilled in the art. The alkoxylation as such (first reaction step of the method according to the present invention) may independently from each other be carried out as a one-step reaction or the alkoxylation as such may be split into two or more individual steps.

It is preferred within the present invention that respective step (alkoxylation) is carried out as a two-step reaction.

In another embodiment of the present invention, the alkoxylation step a) is carried out as a single step reaction in the absence of any water but in the presence of a catalyst.

In a preferred embodiment of the present invention, the alkoxylation step a) is carried out at least in two steps, the first step being carried out in the absence of any catalyst but in the presence of water, the second (and optionally further steps) in the presence of a catalyst but in the absence of water.

Absence of water is defined according to this invention as residual water levels of <1 wt.-% water, preferably <0.5 wt.-% water and more preferably <0.25 wt.-% water.

Within this at least two-step reaction variant of the alkoxylation step a), the catalyst is preferably a basic catalyst. Examples of suitable catalysts are alkali metal and alkaline earth metal hydroxides such as sodium hydroxide, potassium hydroxide and calcium hydroxide, alkali metal alkoxides, in particular sodium and potassium C₁-C₄-alkoxides, such as sodium methoxide, potassium methoxide, sodium ethoxide and potassium tert-butoxide, alkali metal and alkaline earth metal hydrides such as sodium hydride and calcium hydride, and alkali metal carbonates such as sodium carbonate and potassium carbonate. Preference is given to the alkali metal hydroxides and the alkali metal alkoxides, particular preference being given to potassium hydroxide, potassium methoxide and potassium tert-butoxide. Typical use amounts for the base are from 0.05 to 10% by weight, in particular from 0.5 to 2% by weight, based on the total amount of oligoalkylene imine or oligoamine, hydroxy carbon acid and alkylene oxide. Furthermore, the catalyst may also be a multimetal cyanide complex, preferably a DMC (double metal cyanide) catalyst, which are known to the person skilled in the art and described, e.g., in WO 01/083107. It is also possible that the catalyst is a Brönsted acid catalyst, such as montmorillonite or a Lewis acid catalyst, such as boron trifluoride.

In case that the alkoxylation step a) is carried out at least in two steps, the first step is being carried out in the absence of any catalyst but in the presence of water. In this procedure, an initial incipient alkoxylation of the oligoalkylene imine or oligoamine is carried out. In this first part of the step a), the oligoalkylene imine or the oligoamine is reacted only with a portion of the total amount of alkylene oxide used, which corresponds to about 1 mole of alkylene oxide per mole of NH moiety or NH functionality, respectively. This reaction (of the first part of the step a)) is undertaken generally in the absence of a catalyst in aqueous solution at from 70 to 200° C., preferably from 80 to 160° C., under a pressure of up to 10 bar, in particular up to 8 bar. The water content in this first part of step a) is >1 wt.-%, preferably >5 wt.-% and more preferably >10 wt.-%.

All catalyzed steps of alkoxylation in the absence of water may be undertaken in substance (variant a)) or in an organic solvent (variant b)). The process conditions specified below may be used for both steps of the alkoxylation reaction.

In variant a), the aqueous solution of the incipiently alkoxylated oligoalkylene imine or oligoamine obtained in the first step, after addition of the catalyst, is initially dewatered. This can be done in a simple manner by heating to from 80 to 150° C. and distilling off the water under a reduced pressure of from less than 30 mbar. The subsequent reactions with the alkylene oxides are typically conducted at from 70 to 200° C., preferably from 100 to 180° C., and at a pressure of up to 10 bar, in particular up to 8 bar, and a continued stirring time of from about 0.5 to 4 h at from about 100 to 160° C. and constant pressure follows in each case.

Suitable reaction media for variant b) are in particular nonpolar and polar aprotic organic solvents. Examples of particularly suitable nonpolar aprotic solvents include aliphatic and aromatic hydrocarbons such as hexane, cyclohexane, toluene and xylene. Examples of particularly suitable polar aprotic solvents are ethers, in particular cyclic ethers such as tetrahydrofuran and dioxane, N,N-dialkylamides such as dimethylformamide and dimethylacetamide, and N-alkyllactams such as N-methylpyrrolidone. It is of course also possible to use mixtures of these aprotic solvents. Preferred solvents are xylene and toluene.

In variant b) too, the solution obtained in the first step, after addition of catalyst and solvent, is initially dewatered, which is advantageously done by separating out the water at a temperature of from 120 to 180° C., preferably supported by a gentle nitrogen stream. The subsequent reaction with the alkylene oxide may be conducted as in variant a).

In variant a), the alkoxylated oligoalkylene imine or oligoamine (intermediate (I)) is obtained directly in substance. In variant b), the organic solvent is typically removed. Preferably, the intermediate (I) is finally isolated in substance and used directly and without further purification for the next reaction step b). In one embodiment of the present invention, the intermediate (I) might be purified before further use, e.g., by removing volatile organic compounds such as residual monomers and/or by-products, e.g., 1,4-dioxane, in vacuo.

In connection with the second reaction step b) of the method according to the present invention for preparing a modified alkoxylated oligoalkylene imine or a modified alkoxylated oligoamine, the respective intermediate (I) as obtained in step a) is reacted with at least one lactone and/or at least one hydroxy carbon acid. This second reaction step as such is known to a person skilled in the art.

Suitable lactones and/or hydroxy carbon acids can be aliphatic, cycloaliphatic or aromatic.

Particularly suitable aromatic hydroxy carbon acids are hydroxy-substituted benzoic acids and naphthalene carboxylic acids, such as p-hydroxyethyl benzoic acid and 2-hydroxynaphthalene-6-carboxylic acid. Preference is given to aliphatic hydroxy carbon acids, especially to those with hydroxyl groups in the ω position, and their lactones. In general, the aliphatic hydroxy carbon acids have from 1 to 22 alkylene radicals, preferably from 2 to 10 alkylene radicals, more preferably from 2 to 5 alkylene radicals. The alkylene radicals may be linear or branched. Examples which may be mentioned are glycolic acid, lactic acid and its lactide, γ-hydroxybutyric acid and γ-butyrolactone, δ-hydroxyvaleric acid and γ- and δ-valerolactone, ε-hydroxycaproic acid and ε- caprolactone, 12-hydroxystearic acid and ricinoleic acid, and also mixtures, especially including naturally occurring acids. Preferably, glycolic acid, lactic acid, ε-caprolactone or lactide, or mixtures thereof, are employed, even more preferably ε-caprolactone.

It is preferred within this second reaction step b) that the reaction temperature is in a range between 50 to 200° C., more preferred between 70 to 180° C., most preferred in a range between 100 to 170° C.

This second reaction step b) may be carried out in the presence of at least one solvent and/or at least one catalyst. Suitable solvents are preferably selected from xylene, toluene, tetrahydrofuran (THF), methyl-tert. butyl ether or diethyl ether. However, it is preferred within the second reaction step b) that the respective step is carried out without any solvent. In a preferred embodiment of the invention, a catalyst is employed for the second reaction step b). Preferred catalysts are selected from alkali metal hydroxides or alkali metal alkoxides, such as KOMe and NaOMe, or from tin, titanium- or zinc-based catalysts such as dibutyl tin dilaurate, stannous octoate, titanium tetrabutylate, zinc acetate or zinc oxalate.

The esterification according to the second reaction step b) of the inventive process may be generally carried out as known to the person skilled in the art and, for instance, described in Houben-Weyl, Methoden der Organischen Chemie, 4. Edition, volume XIV/2, pages 1 to 30 (1963) and DE^{19529242.} Thus, the esterification of the amino alcohol or the aminoether alcohol with hydroxy carbon acids may usually be carried out at 80 to 250° C., preferably at 120 to 200° C. Furthermore, the said esterification may be carried out in the presence of conventional esterification catalysts know to the person skilled in the art, such as organic metal salts or acids, e.g., titanium (IV) butoxide, zirconium naphthenate, zinc acetate or p-toluenesulfonic acid (generally 0.05 to 3 wt.-%, preferably 0.1 to 1 wt.-%, related to the total amount of reactants), but also without a catalyst, with removal of the water formed during the reaction in the presence or absence of an inert organic solvent, preferably a solvent which forms azeotropes with water. When using the acid lactones or lactides, the esterification, which takes place as an addition or polyaddition reaction (“ring-opening polymerization”), can generally be carried out at temperatures of from 70 to 200° C., in particular from 120 to 160° C., preferably also in the presence of an esterification catalyst, e.g., dibutyl tin dilaurate, tin dioxide, titanium tetrabutylate may be employed in the presence or absence of an organic solvent. The esterification with lactid acid may also be carried out in the presence of water if the water is removed afterwards in order to complete the reaction.

In one embodiment of the present invention, the initially obtained terminal hydroxy groups of the polyester blocks are further reacted within the second reaction step b) of the inventive process with alkylation reagents such as alkyl halides and/or carbon acids and/or carbon acid derivatives such as carbon acid anhydrides, carbon acid esters or carbon acid halides, to obtain terminal end-groups R² selected from unsubstituted or at least monosubstituted C₁-C₂₂-alkyl, C₇-C₂₂-aralkyl, —(CO)—C₁-C₂₂-alkyl, —(CO)—C₂-C₃₀-alkenyl and/or —(CO)—C₇-C₂₂-aralkyl, wherein the substituents are selected from —COOH or a salt thereof. Preference is given to carbon acid anhydrides, specifically to alkyl-chain-substituted succinic anhydrides, examples being C6 to C20-substituted succinic anhydrides. Examples of products commercially available include Pentasize 8 or Pentasize 68 (C18 alkenyl succinic anhydride or C16/C18 alkenyl succinic anhydride, respectively, from Trigon Chemie GmbH).

The amount of residues according to, for example, formula (IIa) and/or formula (IIb), can be controlled by several factors, such as the stoichiometry of the educts employed, the reaction temperature within the individual steps, the amount and/or type of the catalysts employed and/or the selected solvent. In a preferred embodiment of the present invention, residues according to general formula (IIa) account for more than 50% of all residues of the modified alkoxylated oligoalkylene imine or modified alkoxylated oligoamine.

Molecular weights of the inventive modified alkoxylated oligoalkylene imines and modified alkoxylated oligoamines could be determined by gel permeation chromatography (GPC), e.g., by using hexafluoroisopropanol and 0.05% trifluoroacetic acid potassium salt as solvent, preferably in combination with a multi angle laser light scattering (MALLS) detector to obtain absolute weight-average molecular weights (Mw).

The finally obtained modified alkoxylated oligoalkylene imines and modified alkoxylated oligoamines according to this invention have a weight-average molecular weight (based on GPC data) of 1000 to 50000 g/mol, preferably 1500 to 30000 g/mol and even more preferred 2000 to 25000 g/mol. In a preferred embodiment of the invention, the modified alkoxylated oligoalkylene imines and modified alkoxylated oligoamines have a weight-average molecular weight of 2500 to 20000 g/mol.In the context of the present invention, the finally obtained modified alkoxylated oligoalkylene imines and modified alkoxylated oligoamines are therefore described as inventive “polymers”.

Another subject matter of the present invention is the use of the above-mentioned modified alkoxylated oligoalkylene imines or alkoxylated oligoamines in fabric and home care products, in cosmetic formulations, as crude oil emulsion breaker, in pigment dispersions for ink jet inks, in formulations for electro plating, in cementitious compositions and/or as dispersant for agrochemical formulations, preferably in cleaning compositions and/or in fabric and home care products, in particular cleaning compositions for improved oily and fatty stain removal, wherein the cleaning composition is preferably a laundry detergent formulation and/or a manual dish wash detergent formulation, more preferably a liquid laundry detergent formulation and/or a liquid manual dish wash detergent formulation and/or solid or liquid—preferably solid—automatic dish washing formulation.

The inventive modified alkoxylated oligoalkylene imines or alkoxylated oligoamines can be added to cosmetic formulations, as crude oil emulsion breaker, in pigment dispersions for ink jet inks, formulations for electro plating, in cementitious compositions. However, the inventive compounds can also be added to (used in) washing or cleaning compositions.

Another subject-matter of the present invention is, therefore, a cleaning composition, fabric and home care product, industrial and institutional cleaning product, cosmetic formulation, crude oil emulsion breaker, pigment dispersion for ink jet inks, formulation for electro plating, cementitious composition and/or dispersant for agrochemical formulations, comprising at least one modified alkoxylated oligoalkylene imine or alkoxylated oligoamine, as defined above.

Preferably, it is a cleaning composition and/or fabric and home care product, comprising at least one modified alkoxylated oligoalkylene imine or alkoxylated oligoamine, as defined above, preferably for improved oily and fatty stain removal, preferably a laundry detergent formulation and/or a manual dish wash detergent formulation, more preferably a liquid laundry detergent formulation and/or a liquid manual dish wash detergent formulation and/or solid or liquid—preferably solid—automatic dish washing formulation.

In another preferred embodiment of the present invention, the cleaning composition may be used for soil removal of particulate stains and/or oily and fatty stains, and additionally for whiteness maintenance, preferably in laundry care.

In another embodiment, the cleaning composition of the present invention is a hard surface cleaning composition that may be used for cleaning various surfaces such as hard wood, tile, ceramic, plastic, leather, metal, glass.

In another embodiment, the cleaning composition is designed to be used in personal care and pet care compositions such as shampoo compositions, body wash formulations, liquid or solid soaps.

In a further embodiment, this invention also encompasses a composition comprising an inventive polymer as descried herein before, further comprises an antimicrobial agent as disclosed hereinafter, preferably selected from the group consisting of 2-phenoxyethanol, more preferably comprising said antimicrobial agent in an amount ranging from 2 ppm to 5% by weight of the composition; even more preferably comprising 0.1 to 2% of phenoxyethanol.

In a further embodiment, this invention also encompasses a method of preserving an aqueous composition against microbial contamination or growth, such composition comprising an inventive polymer as described herein before, such composition being preferably a detergent composition, such method comprising adding at least one antimicrobial agent selected from the disclosed antimicrobial agents as disclosed hereinafter, such antimicrobial agent preferably being 2-phenoxyethanol.

In a further embodiment, this invention also encompasses a composition, preferably a cleaning composition, more preferably a liquid laundry detergent composition or a liquid hand dish composition, even more preferably a liquid laundry detergent composition, or a liquid softener composition for use in laundry, such composition comprising an inventive polymer as described herein before, such composition further comprising 4,4′-dichoro 2-hydroxydiphenylether in a concentration from 0.001 to 3%, preferably 0.002 to 1%, more preferably 0.01 to 0.6%, each by weight of the composition.

In a further embodiment, this invention also encompasses a method of laundering fabric or of cleaning hard surfaces, which method comprises treating a fabric or a hard surface with a cleaning composition, more preferably a liquid laundry detergent composition or a liquid hand dish composition, even more preferably a liquid laundry detergent composition, or a liquid softener composition for use in laundry, such composition comprising an inventive polymer as described herein before, such composition further comprising 4,4′-dichoro 2-hydroxydiphenylether.

It is also preferred in the present invention that the cleaning composition comprises (besides at least one modified alkoxylated oligoalkylene imine or at least one alkoxylated oligoamine as described above) additionally at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, preferably selected from one or more lipases, hydrolases, amylases, proteases, cellulases, and combinations of at least two of the foregoing types, more preferably at least one enzyme being selected from lipases.

Preferably, the such inventive cleaning composition is a fabric and home care product or an industrial and institutional (I&I) cleaning product, preferably a fabric and home care product, more preferably a laundry detergent or manual dish washing detergent, comprising at least one inventive polymer, and optionally further comprising at least one surfactant or a surfactant system, providing improved removal, dispersion and/or emulsification of soils and/or modification of treated surfaces and/or whiteness maintenance of treated surfaces.

At least one inventive polymer as described herein is present in said inventive cleaning compositions at a concentration of 0.1 to 10, preferably from about 0.25% to 5%, more preferably from about 0.5% to about 3%, and most preferably from about 1% to about 3%, in relation to the total weight of such composition; such cleaning composition may—and preferably does—further comprise a from about 1% to about 70% by weight of a surfactant system.

Even more preferably, the cleaning compositions of the present invention comprising at least one inventive polymer, and optionally further comprising at least one surfactant or a surfactant system, are those for primary cleaning (i.e. removal of stains) within laundry and manual dish wash applications, even more specifically, for removal of oily and fatty stains such as those on fabrics and dishware, and may additionally comprise at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types of enzymes, preferably selected from one or more lipases, hydrolases, amylases, proteases, cellulases, and combinations of at least two of the foregoing types, more preferably at least one enzyme being selected from lipases.

In one preferred embodiment, the cleaning composition of the present invention is a liquid or solid laundry detergent composition.

In another preferred embodiment, the cleaning composition of the present invention is a liquid or solid (e.g. powder or tab/unit dose) detergent composition for manual or automatic dish wash, preferably a liquid manual dish wash detergent composition and/or solid or liquid automatic dish washing formulation.

In one embodiment, the inventive polymers of the present invention may be utilized in cleaning compositions comprising a surfactant system comprising C10-C15 alkyl benzene sulfonates (LAS) as the primary surfactant and one or more additional surfactants selected from non-ionic, cationic, amphoteric, zwitterionic or other anionic surfactants, or mixtures thereof.

In a further embodiment, the inventive polymers of the present invention may be utilized in cleaning compositions, such as laundry detergents of any kind, and the like, comprising C8-C18 linear or branched alkyl ethersulfates with 1-5 ethoxy-units as the primary surfactant and one or more additional surfactants selected from non-ionic, cationic, amphoteric, zwitterionic or other anionic surfactants, or mixtures thereof.

In a further embodiment the inventive polymers of the present invention may be utilized in cleaning compositions, such as laundry detergents of any kind, and the like, comprising C12-C18 alkyl ethoxylate surfactants with 5-10 ethoxy-units as the primary surfactant and one or more additional surfactants selected from anionic, cationic, amphoteric, zwitterionic or other non-ionic surfactants, or mixtures thereof.

In one embodiment of the present invention, the polymer according to the invention is a component of a cleaning composition, such as preferably a laundry or a dish wash formulation, more preferably a liquid laundry or manual dish wash formulation, that each additionally comprise at least one surfactant, preferably at least one anionic surfactant. The selection of the additional surfactants in these embodiments may be dependent upon the application and the desired benefit.

As used herein, the articles “a” and “an” when used in a claim or an embodiment, are understood to mean one or more of what is claimed or described. As used herein, the terms “include(s)” and “including” are meant to be non-limiting, and thus encompass more than the specific item mentioned after those words.

The compositions of the present disclosure can “comprise” (i.e. contain other ingredients), “consist essentially of” (comprise mainly or almost only the mentioned ingredients and other ingredients in only very minor amounts, mainly only as impurities), or “consist of” (i.e. contain only the mentioned ingredients and in addition may contain only impurities not avoidable in an technical environment, preferably only the ingredients) the components of the present disclosure.

Similarly, the terms “substantially free of . . . ” or “substantially free from . . . ” or “(containing/comprising) essentially no . . . ” may be used herein; this means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or even less than 0.1%, or even more less than 0.01%, or even 0%, by weight of the composition.

The term “about”, as used herein, encompasses the exact number “X” mentioned as e.g. “about X %” etc., and small variations of X, including from minus 5 to plus 5% deviation from X (with X for this calculation set to 100%), preferably from minus 2 to plus 2%, more preferably from minus 1 to plus 1%, even more preferably from minus 0,5 to plus 0,5% and smaller variations. Of course, if the value X given itself is already “100%” (such as for purity etc.) then the term “about” clearly can and thus does only mean deviations thereof which are smaller than “100”.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under atmospheric pressure. In all embodiments of the present disclosure, all percentages are by weight of the total composition, unless specifically stated otherwise. All ratios are weight ratios, unless specifically stated otherwise.

### Description of Cleaning Compositions, Formulations and Their Ingredients

The phrase “cleaning composition” as used herein includes compositions and formulations designed for cleaning soiled material. Such compositions and formulations include those designed for cleaning soiled material or surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces.

“Compositions for Fabric and Home Care” include cleaning compositions and formulations including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, preferably during the wash cycle of the laundering or dish washing operation, and as further detailed herein below when describing the use and application of the inventive polymers and compositions comprising such polymers.

The cleaning compositions of the invention may be in any form, namely, in the form of a liquid; a solid such as a powder, granules, agglomerate, paste, tablet, pouches, bar, gel; an emulsion; types delivered in dual- or multi-compartment containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The liquid cleaning compositions of the present invention preferably have a viscosity of from 50 to 10000 mPa*s; liquid manual dish wash cleaning compositions (also liquid manual “dish wash compositions”) have a viscosity of preferably from 100 to 10000 mPa*s, more preferably from 200 to 5000 mPa*s and most preferably from 500 to 3000 mPa*s at 20 1/s and 20° C.; liquid laundry cleaning compositions have a viscosity of preferably from 50 to 3000 mPa*s, more preferably from 100 to 1500 mPa*s and most preferably from 200 to 1000 mPa*s at 20 1/s and 20° C.

The liquid cleaning compositions of the present invention may have any suitable pH-value. Preferably the pH of the composition is adjusted to between 4 and 14. More preferably the composition has a pH of from 6 to 13, even more preferably from 6 to 10, most preferably from 7 to 9. The pH of the composition can be adjusted using pH modifying ingredients known in the art and is measured as a 10% product concentration in demineralized water at 25° C. For example, NaOH may be used and the actual weight % of NaOH may be varied and trimmed up to the desired pH such as pH 8.0. In one embodiment of the present invention, a pH >7 is adjusted by using amines, preferably alkanolamines, more preferably triethanolamine.

Cleaning compositions such as fabric and home care products and formulations for industrial and institutional cleaning, more specifically such as laundry and manual dish wash detergents, are known to a person skilled in the art. Any composition etc. known to a person skilled in the art, in connection with the respective use, can be employed within the context of the present invention by including at least one inventive polymer, preferably at least one polymer in amounts suitable for expressing a certain property within such a composition, especially when such a composition is used in its area of use. One aspect of the present invention is also the use of the inventive polymers as additives for detergent formulations, particularly for liquid detergent formulations, preferably concentrated liquid detergent formulations, or single mono doses for laundry.

The cleaning compositions of the invention may—and preferably do—contain adjunct cleaning additives (also abbreviated herein as “adjuncts”), such adjuncts being preferably in addition to a surfactant system as defined before.

Suitable adjunct cleaning additives include builders, cobuilders, structurants or thickeners, clay soil removal/anti-redeposition agents, polymeric soil release agents, dispersants such as polymeric dispersing agents, polymeric grease cleaning agents, solubilizing agents, chelating agents, enzymes, enzyme stabilizing systems, bleaching compounds, bleaching agents, bleach activators, bleach catalysts, brighteners, malodor control agents, pigments, dyes, opacifiers, hueing agents, dye transfer inhibiting agents, chelating agents, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial agents, anti-oxidants, softeners, carriers, processing aids, pro-perfumes, and perfumes.

Liquid cleaning compositions additionally may comprise—and preferably do comprise at least one of—rheology control/modifying agents, emollients, humectants, skin rejuvenating actives, and solvents.

Solid compositions additionally may comprise—and preferably do comprise at least one of—fillers, bleaches, bleach activators and catalytic materials.

Suitable examples of such cleaning adjuncts and levels of use are found in WO 99/05242, U.S. Pat. Nos. 5,576,282, 6,306,812 B1 and 6,326,348 B1.

Those of ordinary skill in the art will understand that a detersive surfactant encompasses any surfactant or mixture of surfactants that provide cleaning, stain removing, or laundering benefit to soiled material.

Hence, the cleaning compositions of the invention such as fabric and home care products, and formulations for industrial and institutional cleaning, more specifically such as laundry and manual dish wash detergents, preferably additionally comprise a surfactant system and, more preferably, also further adjuncts, as the one described above and below in more detail.

The surfactant system may be composed from one surfactant or from a combination of surfactants selected from anionic surfactants, non-ionic surfactants, cationic surfactants, zwitterionic surfactants, amphoteric surfactants, and mixtures thereof. Those of ordinary skill in the art will understand that a surfactant system for detergents encompasses any surfactant or mixture of surfactants that provide cleaning, stain removing, or laundering benefit to soiled material.

The cleaning compositions of the invention preferably comprise a surfactant system in an amount sufficient to provide desired cleaning properties. In some embodiments, the cleaning composition comprises, by weight of the composition, from about 1% to about 70% of a surfactant system. In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from anionic surfactants, non-ionic surfactants, cationic surfactants, zwitterionic surfactants, amphoteric surfactants, and mixtures thereof.

### (a) Laundry Compositions

In laundry formulations, anionic surfactants contribute usually by far the largest share of surfactants within such formulation. Hence, preferably, the inventive cleaning compositions for use in laundry comprise at least one anionic surfactant and optionally further surfactants selected from any of the surfactants classes described herein, preferably from non-ionic surfactants and/or amphoteric surfactants and/or zwitterionic surfactants and/or cationic surfactants.

Nonlimiting examples of anionic surfactants—which may be employed also in combinations of more than one surfactant—useful herein include C₉-C₂₀ linear alkylbenzenesulfonates (LAS), C₁₀-C₂₀ primary, branched chain and random alkyl sulfates (AS); C₁₀-C₁₈ secondary (2,3) alkyl sulfates; C₁₀-C₁₈ alkyl alkoxy sulfates (AExS) wherein x is from 1 to 30; C₁₀-C₁₈ alkyl alkoxy carboxylates comprising 1 to 5 ethoxy units; mid-chain branched alkyl sulfates as discussed in U.S. Pat. Nos. 6,020,303 and 6,060,443; mid-chain branched alkyl alkoxy sulfates as discussed in U.S. Pat. Nos. 6,008,181 and 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

Preferred examples of suitable anionic surfactants are alkali metal and ammonium salts of C₈-C₁₂-alkyl sulfates, of C₁₂-C₁₈-fatty alcohol ether sulfates, of C₁₂-C₁₈-fatty alcohol polyether sulfates, of sulfuric acid half-esters of ethoxylated C₄-C₁₂-alkylphenols (ethoxylation: 3 to 50 mol of ethylene oxide/mol), of C₁₂-C₁₈-alkylsulfonic acids, of C₁₂-C₁₈ sulfo fatty acid alkyl esters, for example of C₁₂-C₁₈ sulfo fatty acid methyl esters, of C₁₀-C₁₈-alkylarylsulfonic acids, preferably of n-C₁₀-C₁₈-alkylbenzene sulfonic acids, of C₁₀-C₁₈ alkyl alkoxy carboxylates and of soaps such as for example C₈-C₂₄-carboxylic acids. Preference is given to the alkali metal salts of the aforementioned compounds, particularly preferably the sodium salts.

In one embodiment of the present invention, anionic surfactants are selected from n-C₁₀-C₁₈-alkylbenzene sulfonic acids and from fatty alcohol polyether sulfates, which, within the context of the present invention, are in particular sulfuric acid half-esters of ethoxylated C₁₂-C₁₈-alkanols (ethoxylation: 1 to 50 mol of ethylene oxide/mol), preferably of n-C₁₂-C₁₈-alkanols.

In one embodiment of the present invention, also alcohol polyether sulfates derived from branched (i.e. synthetic) C₁₁-C₁₈-alkanols (ethoxylation: 1 to 50 mol of ethylene oxide/mol) may be employed.

Preferably, the alkoxylation group of both types of alkoxylated alkyl sulfates, based on C₁₂-C₁₈-fatty alcohols or based on branched (i.e. synthetic) C₁₁-C₁₈-alcohols, is an ethoxylation group and an average ethoxylation degree of any of the alkoxylated alkyl sulfates is 1 to 5, preferably 1 to 3.

Preferably, the laundry detergent formulation of the present invention comprises from at least 1 wt.-% to 50 wt.-%, preferably in the range from greater than or equal to about 2 wt.-% to equal to or less than about 30 wt.-%, more preferably in the range from greater than or equal to 3 wt.-% to less than or equal to 25 wt.-%, and most preferably in the range from greater than or equal to 5 wt.-% to less than or equal to 25 wt.-% of one or more anionic surfactants as described above, based on the particular overall composition, including other components and water and/or solvents.

In a preferred embodiment of the present invention, anionic surfactants are selected from C₁₀-C₁₅ linear alkylbenzenesulfonates, C₁₀-C₁₈ alkylethersulfates with 1-5 ethoxy units and C₁₀-C₁₈ alkylsulfates.

Non-limiting examples of non-ionic surfactants—which may be employed also in combinations of more than one other surfactant—include: C₈-C₁₈ alkyl ethoxylates, such as, NEODOL® non-ionic surfactants from Shell; ethylenoxide/propylenoxide block alkoxylates as PLURONIC® from BASF; C₁₄-C₂₂ mid-chain branched alkyl alkoxylates, BAEx, wherein x is from 1 to 30, as discussed in U.S. Pat. Nos. 6,153,577, 6,020,303 and 6,093,856; alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Preferred examples of non-ionic surfactants are in particular alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides). Examples of (additional) amphoteric surfactants are so-called amine oxides.

Preferred examples of alkoxylated alcohols and alkoxylated fatty alcohols are, for example, compounds of the general formula (A)

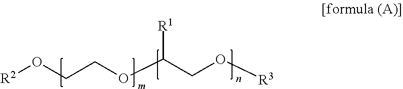

in which the variables are defined as follows:
R¹ is selected from linear C₁-C₁₀-alkyl, preferably ethyl and particularly preferably methyl,
R² is selected from C₈-C₂₂-alkyl, for example n-C₈H₁₇, n-C₁₀H₂₁, n-C₁₂H₂₅, n-C₁₄H₂₉, n-C₁₆H₃₃ or n-C₁₈H₃₇,
R³ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
m and n are in the range from zero to 300, where the sum of n and m is at least one. Preferably, m is in the range from 1 to 100 and n is in the range from 0 to 30.

Here, compounds of the general formula (A) may be block copolymers or random copolymers, preference being given to block copolymers.

Other preferred examples of alkoxylated alcohols and alkoxylated fatty alcohols are, for example, compounds of the general formula (B)

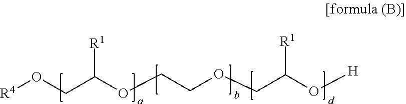

in which the variables are defined as follows:
R¹ is identical or different and selected from linear C₁-C₄-alkyl, preferably identical in each case and ethyl and particularly preferably methyl,
R⁴ is selected from C₆-C₂₀-alkyl, in particular n-C₈H₁₇, n-C₁₀H₂₁, n-C₁₂H₂₅, n-C₁₄H₂₉, n-C₁₆H₃₃, n-C₁₈H₃₇,
a is a number in the range from zero to 6, preferably 1 to 6,
b is a number in the range from zero to 20, preferably 4 to 20,
d is a number in the range from 4 to 25.

Preferably, at least one of a and b is greater than zero.

Here, compounds of the general formula (B) may be block copolymers or random copolymers, preference being given to block copolymers.

Further suitable non-ionic surfactants are selected from di- and multiblock copolymers, composed of ethylene oxide and propylene oxide. Further suitable non-ionic surfactants are selected from ethoxylated or propoxylated sorbitan esters. Alkylphenol ethoxylates or alkyl polyglycosides or polyhydroxy fatty acid amides (glucamides) are likewise suitable. An overview of suitable further non-ionic surfactants can be found in EP-A 0 851 023 and in DE-A 198 19 187.

Mixtures of two or more different non-ionic surfactants may of course also be present.

In a preferred embodiment of the present invention, non-ionic surfactants are selected from C_{12/14} and C_{16/18} fatty alkoholalkoxylates, C_{13/15} oxoalkoholalkoxylates, C₁₃-alkoholalkoxylates, and 2-propylheptylalkoholalkoxylates, each of them with 3-15 ethoxy units, preferably 5-10 ethoxy units, or with 1-3 propoxy- and 2-15 ethoxy units.

Non-limiting examples of amphoteric surfactants—which may be employed also in combinations of more than one other surfactant—include: water-soluble amine oxides containing one alkyl moiety of from about 8 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. Nos. 4,681,704, and 4,133,779. Suitable surfactants include thus so-called amine oxides, such as lauryl dimethyl amine oxide (“lauramine oxide”).

Preferred examples of amphoteric surfactants are amine oxides. Preferred amine oxides are alkyl dimethyl amine oxides or alkyl amido propyl dimethyl amine oxides, more preferably alkyl dimethyl amine oxides and especially coco dimethyl amino oxides. Amine oxides may have a linear or mid-branched alkyl moiety. Typical linear amine oxides include water-soluble amine oxides containing one R¹=C₈₋₁₈ alkyl moiety and two R² and R³ moieties selected from the group consisting of C₁-C₃ alkyl groups and C₁-C₃ hydroxyalkyl groups. Preferably, the amine oxide is characterized by the formula

R¹—N(R²)(R³)—O

wherein R¹ is a C₈₋₁₈ alkyl and R² and R³ are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides. Preferred amine oxides include linear C_{10,} linear C₁₀-C₁₂, and linear C₁₂-C₁₄ alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the alpha carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that (n1-n2) is less than or equal to 5, preferably 4, most preferably from 0 to 4 carbon atoms in at least 50 wt.-%, more preferably at least 75 wt.-% to 100 wt.-% of the mid-branched amine oxides for use herein. The amine oxide further comprises two moieties, independently selected from a C₁-C₃ alkyl, a C₁-C₃ hydroxyalkyl group, or a polyethylene oxide group containing an average of from about 1 to about 3 ethylene oxide groups. Preferably the two moieties are selected from a C₁-C₃ alkyl, more preferably both are selected as a C₁ alkyl.

In a preferred embodiment of the present invention, amphoteric surfactants are selected from C₈-C₁₈ alkyl-dimethyl aminoxides and C₈-C₁₈ alkyl-di(hydroxyethyl)aminoxide.

Cleaning compositions may also contain zwitterionic surfactants-which may be employed also in combinations of more than one other surfactant.

Suitable zwitterionic surfactants include betaines, such as alkyl betaines, alkylamidobetaine, amidazoliniumbetaine, sulfobetaine (INCI Sultaines) as well as the phosphobetaines. Examples of suitable betaines and sulfobetaines are the following (designated in accordance with INCI): Almond amidopropyl of betaines, Apricotamidopropyl betaines, Avocadamidopropyl of betaines, Babassuamidopropyl of betaines, Behenamidopropyl betaines, Behenyl of betaines, Canol amidopropyl betaines, Capryl/Capramidopropyl betaines, Carnitine, Cetyl of betaines, Cocamidoethyl of betaines, Cocamidopropyl betaines, Cocamidopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucamidopropyl Hydroxysultaine, Hydrogenated Tallow of betaines, Isostearamid-opropyl betaines, Lauramidopropyl betaines, Lauryl of betaines, Lauryl Hydroxysultaine, Lauryl Sultaine, Milkamidopropyl betaines, Minkamidopropyl of betaines, Myristamidopropyl betaines, Myristyl of betaines, Oleamidopropyl betaines, Oleamidopropyl Hydroxysultaine, Oleyl of betaines, Olivamidopropyl of betaines, Palmamidopropyl betaines, Palmitamidopropyl betaines, Palmitoyl Carnitine, Palm Kernelamidopropyl betaines, Polytetrafluoroethylene Acetoxypropyl of betaines, Ricinoleam idopropyl betaines, Sesamidopropyl betaines, Soyamidopropyl betaines, Stearamidopropyl betaines, Stearyl of betaines, Tallowamidopropyl betaines, Tallowamidopropyl Hydroxysultaine, Tallow of betaines, Tallow Dihydroxyethyl of betaines, Undecylenamidopropyl betaines and Wheat Germamidopropyl betaines.

Preferred betaines are, for example, C₁₂-C₁₈-alkylbetaines and sulfobetaines. The zwitterionic surfactant preferably is a betaine surfactant, more preferable a Cocoamidopropylbetaine surfactant.

Non-limiting examples of cationic surfactants—which may be employed also in combinations of more than one other surfactant—include: the quaternary ammonium surfactants, which can have up to 26 carbon atoms include: alkoxylated quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and 6,022,844; and amino surfactants as discussed in U.S. Pat. No. 6,221,825 and WO 00/47708, specifically amido propyldimethyl amine (APA).

Compositions according to the invention may comprise at least one builder. In the context of the present invention, no distinction will be made between builders and such components elsewhere called “co-builders”. Examples of builders are complexing agents, hereinafter also referred to as complexing agents, ion exchange compounds, and precipitating agents. Builders are selected from citrate, phosphates, silicates, carbonates, phosphonates, amino carboxylates and polycarboxylates.

In the context of the present invention, the term citrate includes the mono- and the dialkali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates such as sodium tripolyphosphate. Preferably, however, the composition according to the invention is free from phosphates and polyphosphates, with hydrogenphosphates being subsumed, for example free from trisodium phosphate, pentasodium tripolyphosphate and hexasodium metaphosphate (“phosphate-free”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry.

The term carbonates includes alkali metal carbonates and alkali metal hydrogen carbonates, preferred are the sodium salts. Particularly preferred is Na₂CO₃.

Examples of phosphonates are hydroxyalkanephosphonates and aminoalkane-phosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylene diaminetetra- methylenephosphonate (EDTMP), diethylenetriaminepentamethylenephosphonate (DTPMP), and also their higher homologues. They are preferably used in the form of the neutrally reacting sodium salts, e.g. as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaacetate, propylene diamines tetraacetic acid, ethanol-diglycines, methylglycine diacetate, and glutamine diacetate. The term amino carboxylates and polycarboxylates also include their respective non-substituted or substituted ammonium salts and the alkali metal salts such as the sodium salts, in particular of the respective fully neutralized compound.

Silicates in the context of the present invention include in particular sodium disilicate and sodium metasilicate, alumosilicates such as for example zeolites and sheet silicates, in particular those of the formula α-Na₂Si₂O₅, β-Na₂Si₂O₅, and δ-Na₂Si₂O₅.

Compositions according to the invention may contain one or more builder selected from materials not being mentioned above. Examples of builders are α-hydroxypropionic acid and oxidized starch.

In one embodiment of the present invention, builder is selected from polycarboxylates. The term “polycarboxylates” includes non-polymeric polycarboxylates such as succinic acid, C₂-C₁₆-alkyl disuccinates, C₂-C₁₆-alkenyl disuccinates, ethylene diamine N,N′-disuccinic acid, tartaric acid diacetate, alkali metal malonates, tartaric acid monoacetate, propanetricarboxylic acid, butanetetracarboxylic acid and cyclopentanetetracarboxylic acid.

Oligomeric or polymeric polycarboxylates are for example polyaspartic acid or in particular alkali metal salts of (meth)acrylic acid homopolymers or (meth)acrylic acid copolymers.

Suitable co-monomers are monoethylenically unsaturated dicarboxylic acids such as maleic acid, fumaric acid, maleic anhydride, itaconic acid and citraconic acid. A suitable polymer is in particular polyacrylic acid, which preferably has a weight-average molecular weight M_{w} in the range from 2000 to 40 000 g/mol, preferably 2000 to 10 000 g/mol, in particular 3000 to 8000 g/mol. Further suitable copolymeric polycarboxylates are in particular those of acrylic acid with methacrylic acid and of acrylic acid or methacrylic acid with maleic acid and/or fumaric acid.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilically or hydrophobically modified co-monomer as listed below.

Suitable hydrophobic co-monomers are, for example, isobutene, diisobutene, butene, pentene, hexene and styrene, olefins with ten or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic co-monomers are monomers with sulfonate or phosphonate groups, and also non-ionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

Moreover, amphoteric polymers can also be used as builders.

Compositions according to the invention can comprise, for example, in the range from in total 0.1 to 70% by weight, preferably 10 to 50% by weight, preferably up to 20% by weight, of builder(s), especially in the case of solid formulations. Liquid formulations according to the invention preferably comprise in the range of from 0.1 to 8% by weight of builder.

Formulations according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium. In one embodiment of the present invention, a pH >7 is adjusted by using amines, preferably alkanolamines, more preferably triethanolamine.

In one embodiment of the present invention, the laundry formulation according to the invention comprises additionally at least one enzyme.

Useful enzymes are, for example, one or more hydrolases selected from lipases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, preferably selected from one or more lipases, hydrolases, amylases, proteases, cellulases, and combinations of at least two of the foregoing types, more preferably at least one enzyme being selected from lipases.

Such enzyme(s) can be incorporated at levels sufficient to provide an effective amount for cleaning. The preferred amount is in the range from 0.001% to 5% of active enzyme by weight in the detergent composition according to the invention. Together with enzymes also enzyme stabilizing systems may be used such as for example calcium ions, boric acid, boronic acid, propylene glycol and short chain carboxylic acids. In the context of the present invention, short chain carboxylic acids are selected from monocarboxylic acids with 1 to 3 carbon atoms per molecule and from dicarboxylic acids with 2 to 6 carbon atoms per molecule. Preferred examples are formic acid, acetic acid, propionic acid, oxalic acid, succinic acid, HOOC(CH₂)₃COOH, adipic acid and mixtures from at least two of the foregoing, as well as the respective sodium and potassium salts.

Compositions according to the invention may comprise one or more bleaching agent (bleaches).

Preferred bleaches are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H₂SO₅ and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Formulations according to the invention can comprise one or more bleach catalysts. Bleach catalysts can be selected from oxaziridinium-based bleach catalysts, bleach-boosting transition metal salts or transition metal complexes such as, for example, manganese, iron, cobalt, ruthenium- or molybdenum-salen complexes or carbonyl complexes. Manganese, iron, cobalt, ruthenium, molybdenum, titanium, vanadium and copper complexes with nitrogen-containing tripod ligands and also cobalt, iron, copper- and ruthenium-amine complexes can also be used as bleach catalysts.

Formulations according to the invention can comprise one or more bleach activators, for example tetraacetyl ethylene diamine, tetraacetylmethylene diamine, tetra-acetylglycoluril, tetraacetylhexylene diamine, acylated phenolsulfonates such as for example n-nonanoyl- or isononanoyloxybenzene sulfonates, N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Formulations according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxy-hydroquinone, gallic acid, phloroglucinol or pyrogallol.

In one embodiment of the present invention, formulations according to the invention comprise in total in the range from 0.1 to 1.5% by weight of corrosion inhibitor.

Formulations according to the invention may also comprise further cleaning polymers and/or soil release polymers.

The additional cleaning polymers may include, without limitation, “multifunctional polyethylene imines” (for example BASF's Sokalan® HP20) and/or “multifunctional diamines” (for example BASF's Sokalan@ HP96). Such multifunctional polyethylene imines are typically ethoxylated polyethylene imines with a weight-average molecular weight M_{w} in the range from 3000 to 250000, preferably 5000 to 200000, more preferably 8000 to 100000, more preferably 8000 to 50000, more preferably 10000 to 30000, and most preferably 10000 to 20000 g/mol. Suitable multifunctional polyethylene imines have 80 wt.-% to 99 wt.-%, preferably 85 wt.-% to 99 wt.-%, more preferably 90 wt.-% to 98 wt.-%, most preferably 93 wt.-% to 97 wt.-% or 94 wt.-% to 96 wt.-% ethylene oxide side chains, based on the total weight of the materials. Ethoxylated polyethylene imines are typically based on a polyethylene imine core and a polyethylene oxide shell. Suitable polyethylene imine core molecules are polyethylene imines with a weight-average molecular weight M_{w} in the range of 500 to 5000 g/mol. Preferably employed is a molecular weight from 500 to 1000 g/mol, even more preferred is a M_{w} of 600 to 800 g/mol. The ethoxylated polymer then has on average 5 to 50, preferably 10 to 35 and even more preferably 20 to 35 ethylene oxide (EO) units per NH-functional group.

Suitable multifunctional diamines are typically ethoxylated C₂ to C₁₂ alkylene diamines, preferably hexamethylene diamine, which are further quaternized and optionally sulfated. Typical multifunctional diamines have a weight-average molecular weight M_{w} in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contains on average 10 to 50, preferably 15 to 40 and even more preferably 20 to 30 ethylene oxide (EO) groups per NH-functional group, and which preferably bears two cationic ammonium groups and two anionic sulfate groups.

In a preferred embodiment of the present invention, the cleaning compositions may contain at least one multifunctional polyethylene imine and/or at least one multifunctional diamine to improve the cleaning performance, such as preferably improve the stain removal ability, especially the primary detergency of particulate stains on polyester fabrics of laundry detergents. The multifunctional polyethylene imines or multifunctional diamines or mixtures thereof according to the descriptions above may be added to the laundry detergents and cleaning compositions in amounts of generally from 0.05 to 15 wt.-%, preferably from 0.1 to 10 wt.-% and more preferably from 0.25 to 5 wt.-% and even as low as up to 2 wt. %, based on the particular overall composition, including other components and water and/or solvents.

Thus, one aspect of the present invention is a laundry detergent composition, in particular a liquid laundry detergent, comprising (i) at least one inventive polymer and (ii) at least one compound selected from multifunctional polyethylene imines and multifunctional diamines and mixtures thereof.

In one embodiment of the present invention, the ratio of the at least one inventive polymer and (ii) the at least one compound selected from multifunctional polyethylene imines and multifunctional diamines and mixtures thereof, is from 10:1 to 1:10, preferably from 5:1 to 1:5 and more preferably from 3:1 to 1:3.

Laundry formulations comprising the inventive polymer may also comprise at least one antimicrobial agent.

Especially of interest for the cleaning compositions and fabric and home care products and specifically in the laundry formulations are any of the following antimicrobial agents and/or preservatives:

4,4′-dichloro 2-hydroxydiphenyl ether (further names: 5-chloro-2-(4-chlorophenoxy) phenol, Diclosan, DCPP), Tinosan® HP 100 (30 wt. % of DCPP in in 1,2-propylene glycol); 2-Phenoxyethanol (further names: Phenoxyethanol, Methylphenylglycol, Phenoxetol, ethylene glycol phenyl ether, Ethylene glycol monophenyl ether, 2-(phenoxy) ethanol, 2-phenoxy-1-ethanol); 2-bromo-2-nitropropane-1,3-diol (further names: 2-bromo-2-nitro-1,3-propanediol, Bronopol); Glutaraldehyde (further names: 1-5-pentandial, pentane-1,5-dial, glutaral, glutardialdehyde); Glyoxal (further names: ethandial, oxylaldehyde, 1,2-ethandial); 5-bromo-5-nitro-1,3-dioxane (further names: 5-bromo-5-nitro-m-dioxane, Bronidox®);Phenoxypropanol (further names: propylene glycol phenyl ether, phenoxyisopropanol 1-phenoxy-2-propanol, 2-phenoxy-1-propanol); Glucoprotamine (chemical description: reaction product of glutamic acid and alkylpropylenediamine, further names: Glucoprotamine 50); Cyclohexyl hydroxyl diazenium-1-oxide, potassium salt (further names: N-cyclohexyl-diazenium dioxide, Potassium HDO, Xyligene,); Formic acid (further names: methanoic acid, Protectol® FM, Protectol® FM 75, Protectol® FM 85, Protectol® FM 99, Lutensol® FM) and its salts, e.g. sodium formiate); Tetrahydro-3,5-dimethyl-1,3,5-thiadia-zine-2-thione (further names: 3,5-dimethyl-1,3-5-thiadiazinane-2-thione, Dazomet; 2,4-dichlorobenzyl alcohol (, further names: dichlorobenzyl alcohol, 2,4-dichloro-benzenemethanol, (2,4-dichloro-phenyl)-methanol, DCBA); 1-propanol (further names: n-propanol, propan-1-ol, n-propyl alcohol; 1,3,5-Tris-(2-hydroxyethyl)-hexahydro-1,3,5-triazin (further names: Hexyhydrotriazine, Tris(hydroethyl)-hexyhydrotriazin, hexyhydro-1,3-5-tris(2-hydroxyethyl)-s-triazine, 2,2′,2″-(hexahydro-1,3,5-triazine-1,3,5-triyl)triethanol; 2-butyl-benzo[d]isothiazol-3-one (“BBIT”); 2-methyl-2H-isothiazol-3-one (“MIT”); 2-octyl-2H-isothiazol-3-one (“OIT”); 5-Chloro-2-methyl-2H-isothiazol-3-one (“CIT” or “CMIT”); Mixture of 5-chloro-2-methyl-2H-isothiazol-3-one (“CMIT”) and 2-methyl-2H-isothiazol-3-one (“MIT”) (Mixture of CMIT/MIT); 1,2-benzisothiazol-3(2H)-one (“BIT”); Hexa-2,4-dienoic acid (trivial name “sorbic acid”) and its salts, e.g., calcium sorbate, sodium sorbate; potassium (E,E)-hexa-2,4-dienoate (Potassium Sorbate); Lactic acid and its salts; L-(+)-lactic acid; especially sodium lactate; Benzoic acid and salts of benzoic acid, e.g., sodium benzoate, ammonium benzo-ate, calcium benzoate, magnesium benzoate, MEA-benzoate, potassium benzoate; Salicylic acid and its salts, e.g., calcium salicylate, magnesium salicylate, MEA salicylate, sodium salicylate, potassium salicylate, TEA salicylate; Benzalkonium chloride, benzalkonium bromide, benzalkonium saccharinate; Didecyldimethylammonium chloride (“DDAC”); N-(3-aminopropyl)-N-dodecylpropane-1,3-diamine (“Diamine”); Peracetic acid; Hydrogen peroxide.

At least one antimicrobial agent or preservative may be added to the inventive composition in a concentration of 0.001 to 10% relative to the total weight of the composition.

The antimicrobial agent may be selected from the list consisting of 2-phenoxyethanol (CAS-no. 122-99-6, for example Protectol® PE available from BASF) and 4,4′-dichloro-2-hydroxydiphenylether (CAS: 3380-30-1), and combinations thereof.

The 4,4′-dichloro-2-hydroxydiphenylether may be used as a solution, for example a solution of 30 wt.-% of 4,4′-dichloro-2-hydroxydiphenylether in 1,2-propyleneglycol, e.g. Tinosan® HP 100 available from BASF.

The inventive laundry formulation may comprise at least one antimicrobial agent from the above list and/or a combination thereof, and/or a combination with at least one further antimicrobial agent not listed here.

The antimicrobial agent may be added to the inventive laundry formulation in a concentration of 0.0001 wt.-% to 10 wt.-% relative to the total weight of the composition. Preferably, the formulation contains 2-phenoxyethanol in a concentration of 0.01 wt.-% to 5 wt.-%, more preferably 0.1 wt.-% to 2 wt.-% and/or 4,4′-dichloro 2-hydroxydiphenyl ether in a concentration of 0.001 wt.-% to 1 wt.-%, more preferably 0.002 wt.-% to 0.6 wt.-% (in all cases relative to the total weight of the composition).

Formulations according to the invention may also comprise water and/or additional organic solvents, e.g. ethanol or propylene glycol.

Further optional ingredients may be but are not limited to viscosity modifiers, cationic surfactants, foam boosting or foam reducing agents, perfumes, dyes, optical brighteners, and dye transfer inhibiting agents.

### (b) Dish Wash Compositions

Another aspect of the present invention is also a dish wash composition, comprising at least one inventive polymer as described above.

Thus, an aspect of the present invention is also the use of the inventive polymer as described above, in dish wash applications, such as manual or automated dish wash applications.

Dish wash compositions according to the invention can be in the form of a liquid, semi-liquid, cream, lotion, gel, or solid composition, solid embodiments encompassing, for example, powders and tablets. Liquid compositions are typically preferred for manual dish wash applications, whereas solid formulations and pouch formulations (where the pouches may contain also solids in addition to liquid ingredients) are typically preferred for automated dish washing compositions; however, in some areas of the world also liquid automated dish wash compositions are used and are thus of course also encompassed by the term “dish wash composition”.

The dish wash compositions are intended for direct or indirect application onto dishware and metal and glass surfaces, such as drinking and other glasses, beakers, dish and cooking ware like pots and pans, and cutlery such as forks, spoons, knives and the like. The inventive method of cleaning dishware, metal and/or glass surfaces comprises the step of applying the dish wash cleaning composition, preferably in liquid form, onto the surface, either directly or by means of a cleaning implement, i.e., in neat form. The composition is applied directly onto the surface to be treated and/or onto a cleaning device or implement such as a dish cloth, a sponge or a dish brush and the like without undergoing major dilution (immediately) prior to the application. The cleaning device or implement is preferably wet before or after the composition is delivered to it. In the method of the invention, the composition can also be applied in diluted form.

Both neat and dilute application give rise to superior cleaning performance, i.e. the formulations of the invention containing at least one inventive polymer exhibit excellent degreasing properties. The effort of removing fat and/or oily soils from the dishware, metal and/or glass surfaces is decreased due to the presence of the inventive polymer, even when the level of surfactant used is lower than in conventional compositions.

Preferably the composition is formulated to provide superior grease cleaning (degreasing) properties, long-lasting suds and/or improved viscosity control at decreased temperature exposures; preferably at least two, more preferably all three properties are present in the inventive dish wash composition. Optional—preferably present—further benefits of the inventive manual dish wash composition include soil removal, shine, and/or hand care; more preferably at least two and most preferably all three further benefits are present in the inventive dish wash composition.

In one embodiment of the present invention, the inventive polymer is one component of a manual dish wash formulation that additionally comprises at least one surfactant, preferably at least one anionic surfactant.

In another embodiment of the present invention, the inventive polymer is one component of a manual dish wash formulation that additionally comprises at least one anionic surfactant and at least one other surfactant, preferably selected from amphoteric surfactants and/or zwitterionic surfactants. In a preferred embodiment of the present invention, the manual dish wash formulations contain at least one amphoteric surfactant, preferably an amine oxide, or at least one zwitterionic surfactant, preferably a betaine, or mixtures thereof, to aid in the foaming, detergency, and/or mildness of the detergent composition.

Examples of suitable anionic surfactants are already mentioned above for laundry compositions.

Preferred anionic surfactants for dish wash compositions are selected from C₁₀-C₁₅ linear alkylbenzenesulfonates, C₁₀-C₁₈ alkylethersulfates with 1-5 ethoxy units and C₁₀-C₁₈ alkylsulfates.

Preferably, the manual dish wash detergent formulation of the present invention comprises from at least 1 wt.-% to 50 wt.-%, preferably in the range from greater than or equal to about 3 wt.-% to equal to or less than about 35 wt.-%, more preferably in the range from greater than or equal to 5 wt.-% to less than or equal to 30 wt.-%, and most preferably in the range from greater than or equal to 5 wt.-% to less than or equal to 20 wt.-% of one or more anionic surfactants as described above, based on the particular overall composition, including other components and water and/or solvents.

Dish wash compositions according to the invention may comprise at least one amphoteric surfactant.

Examples of suitable amphoteric surfactants for dish wash compositions are already mentioned above for laundry compositions.

Preferred amphoteric surfactants for dish wash compositions are selected from C₈-C₁₈ alkyl-dimethyl aminoxides and C₈-C₁₈ alkyl-di(hydroxyethyl)aminoxide.

The manual dish wash detergent composition of the invention preferably comprises from 1 wt.-% to 15 wt.-%, preferably from 2 wt.-% to 12 wt.-%, more preferably from 3 wt.-% to 10 wt.-% of the composition of an amphoteric surfactant, preferably an amine oxide surfactant. Preferably the composition of the invention comprises a mixture of the anionic surfactants and alkyl dimethyl amine oxides in a weight ratio of less than about 10:1, more preferably less than about 8:1, more preferably from about 5:1 to about 2:1.

Addition of the amphoteric surfactant provides good foaming properties in the dish wash composition.

Dish wash compositions according to the invention may comprise at least one zwitterionic surfactant.

Examples of suitable zwitterionic surfactants for dish wash compositions are already mentioned above for laundry compositions.

Preferred zwitterionic surfactants for dish wash compositions are selected from betaine surfactants, more preferable from Cocoamidopropylbetaine surfactants.

In a preferred embodiment of the present invention, the zwitterionic surfactant is Cocamidopropylbetaine.

The manual dish wash detergent composition of the invention optionally comprises from 1 wt.-% to 15 wt.-%, preferably from 2 wt.-% to 12 wt.-%, more preferably from 3 wt.-% to 10 wt.-% of the composition of a zwitterionic surfactant, preferably a betaine surfactant.

Dish wash compositions according to the invention may comprise at least one cationic surfactant.

Examples of suitable cationic surfactants for dish wash compositions are already mentioned above for laundry compositions.

Cationic surfactants, when present in the composition, are present in an effective amount, more preferably from 0.1 wt.-% to 5 wt.-%, preferably 0.2 wt.-% to 2 wt.-% of the composition.

Dish wash compositions according to the invention may comprise at least one non-ionic surfactant.

Examples of suitable non-ionic surfactants for dish wash compositions are already mentioned above for laundry compositions.

Preferred non-ionic surfactants are the condensation products of Guerbet alcohols with from 2 to 18 moles, preferably 2 to 15, more preferably 5-12 of ethylene oxide per mole of alcohol. Other preferred non-ionic surfactants for use herein include fatty alcohol polyglycol ethers, alkylpolyglucosides and fatty acid glucamides.

The manual hand dish detergent composition of the present invention may comprise from 0.1 wt.-% to 10 wt.-%, preferably from 0.3 wt.-% to 5 wt.-%, more preferably from 0.4 wt.-% to 2 wt.-% of the composition, of a linear or branched C10 alkoxylated non-ionic surfactant having an average degree of alkoxylation of from 2 to 6, preferably from 3 to 5. Preferably, the linear or branched C10 alkoxylated non-ionic surfactant is a branched C10 ethoxylated non-ionic surfactant having an average degree of ethoxylation of from 2 to 6, preferably of from 3 to 5. Preferably, the composition comprises from 60 wt.-% to 100 wt.-%, preferably from 80 wt.-% to 100 wt.-%, more preferably 100 wt.-% of the total linear or branched C10 alkoxylated non-ionic surfactant of the branched C10 ethoxylated non-ionic surfactant. The linear or branched C10 alkoxylated non-ionic surfactant preferably is a 2-propylheptyl ethoxylated non-ionic surfactant having an average degree of ethoxylation of from 3 to 5. A suitable 2-propylheptyl ethoxylated non-ionic surfactant having an average degree of ethoxylation of 4 is Lutensol® XP40, commercially available from BASF SE, Ludwigshafen, Germany. The use of a 2-propylheptyl ethoxylated non-ionic surfactant having an average degree of ethoxylation of from 3 to 5 leads to improved foam levels and long-lasting suds.

Thus, one aspect of the present invention is a manual dish wash detergent composition, in particular a liquid manual dish wash detergent composition, comprising (i) at least one inventive polymer, and (ii) at least one further 2-propylheptyl ethoxylated non-ionic surfactant having an average degree of ethoxylation of from 3 to 5.

Dish wash compositions according to the invention may comprise at least one hydrotrope in an effective amount, to ensure the compatibility of the liquid manual dish wash detergent compositions with water.

Suitable hydrotropes for use herein include anionic hydrotropes, particularly sodium, potassium, and ammonium xylene sulfonate, sodium, potassium and ammonium toluene sulfonate, sodium, potassium, and ammonium cumene sulfonate, and mixtures thereof, and related compounds, as disclosed in U.S. Pat. No. 3,915,903.

The liquid manual dish wash detergent compositions of the present invention typically comprise from 0.1 wt.-% to 15 wt.-% of the total liquid detergent composition of a hydrotrope, or mixtures thereof, preferably from 1 wt.-% to 10 wt.-%, most preferably from 2 wt.-% to 5 wt.-% of the total liquid manual dish wash composition.

Dish wash compositions according to the invention may comprise at least one organic solvent.

Examples of organic solvents are C₄-C₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof.

When present, the liquid dish wash compositions will contain from 0.01 wt.-% to 20 wt.-%, preferably from 0.5 wt.-% to 15 wt.-%, more preferably from 1 wt.-% to 10 wt.-%, most preferably from 1 wt.-% to 5 wt.-% of the liquid detergent composition of a solvent. These solvents may be used in conjunction with an aqueous liquid carrier, such as water, or they may be used without any aqueous liquid carrier being present. At higher solvent systems, the absolute values of the viscosity may drop but there is a local maximum point in the viscosity profile.

The dish wash compositions herein may further comprise from 30 wt.-% to 90 wt.-% of an aqueous liquid carrier, comprising water, in which the other essential and optional ingredients are dissolved, dispersed or suspended. More preferably the compositions of the present invention comprise from 45 wt.-% to 85 wt.-%, even more preferably from 60 wt.-% to 80 wt.-% of the aqueous liquid carrier. The aqueous liquid carrier, however, may contain other materials which are liquid, or which dissolve in the liquid carrier, at room temperature (25° C.) and which may also serve some other function besides that of an inert filler.

Dish wash compositions according to the invention may comprise at least one electrolyte.

Suitable electrolytes are preferably selected from inorganic salts, even more preferably selected from monovalent salts, most preferably sodium chloride.

The liquid manual dish wash compositions according to the invention may comprise from 0.1 wt.-% to 5 wt.-%, preferably from 0.2 wt.-% to 2 wt.-% of the composition of an electrolyte.

Manual dish wash formulations comprising the inventive polymer may also comprise at least one antimicrobial agent.

Examples of suitable antimicrobial agents for dish wash compositions are already mentioned above for laundry compositions.

The antimicrobial agent may be added to the inventive hand dish wash composition in a concentration of 0.0001 wt.-% to 10 wt.-% relative to the total weight of composition. Preferably, the formulation contains 2-phenoxyethanol in a concentration of 0.01 wt.-% to 5 wt.-%, more preferably 0.1 wt.-% to 2 wt.-% and/or 4,4′-dichloro 2-hydroxydiphenyl ether in a concentration of 0.001 wt.-% to 1 wt.-%, more preferably 0.002 wt.-% to 0.6 wt.-% (in all cases relative to the total weight of the composition).

Further additional ingredients are such as but not limited to conditioning polymers, cleaning polymers, surface modifying polymers, soil flocculating polymers, rheology modifying polymers, enzymes, structurants, builders, chelating agents, cyclic diamines, structurants, emollients, humectants, skin rejuvenating actives, carboxylic acids, scrubbing particles, bleach and bleach activators, perfumes, malodor control agents, pigments, dyes, opacifiers, beads, pearlescent particles, microcapsules, antibacterial agents, pH adjusters including NaOH and alkanolamines such as monoethanolamines and buffering means.

### (c) General Cleaning Compositions and Formulations

The liquid formulations disclosed in this chapter may comprise 0 to 2% 2-phenoxyethanol, preferably about 1%, in addition to all other mentioned ingredients.

The above and below disclosed liquid formulations may comprise 0-0.2% 4,4′-dichoro 2-hydroxydiphenylether, preferably about 0.15%, in addition to all other mentioned ingredients. The bleach-free solid laundry compositions may comprise 0-0.2% 4,4′-dichoro 2-hydroxydiphenylether, preferably about 0.15%, in addition to all other mentioned ingredients.

The formulations disclosed in this chapter may—in addition to all other mentioned ingredients—comprise one or more enzymes selected from those disclosed herein above, more preferably a protease and/or an amylase, wherein even more preferably the protease is a protease with at least 90% sequence identity to SEQ ID NO: 22 of EP1921147B1 and having the amino acid substitution R101E (according to BPN′ numbering) and wherein the amylase is an amylase with at least 90% sequence identity to SEQ ID NO: 54 of WO2021032881A1, such enzyme(s) preferably being present in the formulations at levels from about 0.00001% to about 5%, preferably from about 0.00001% to about 2%, more preferably from about 0.0001% to about 1%, or even more preferably from about 0.001% to about 0.5% enzyme protein by weight of the composition.

The following compositions shown below including those in the tables disclose general cleaning compositions of certain types, which correspond to typical compositions correlating with typical washing conditions as typically employed in various regions and countries of the world. The at least one inventive polymer may be added to such formulation(s) in suitable amounts as outlined herein.

When the shown composition does not comprise an inventive polymer, such composition is a comparative composition. When it comprises an inventive polymer, especially in the amounts that are described herein as preferred, more preferred etc. ranges, such compositions are considered to fall within the scope of the present invention.

In a preferred embodiment the polymer according to the present invention is used in a laundry detergent.

Liquid laundry detergents according to the present invention are composed of:

| | |
|---|---|
| 0.05-20% | of at least one inventive polymer |
| 1-50% | of surfactants |
| 0.1-40% | of builders, cobuilders and/or chelating agents |
| 0.1-50% | other adjuncts |

water to add up 100%.

Preferred liquid laundry detergents according to the present invention are composed of:

| | |
|---|---|
| 0.2-6% | of at least one inventive polymer |
| 5-40% | of anionic surfactants selected from C10-C15- LAS and |
| | C10-C18 alkyl ethersulfates containing 1-5 ethoxy-units |
| 1.5-10% | of nonionic surfactants selected from C10-C18-alkyl |
| | ethoxylates containing 3-10 ethoxy-units |
| 2-20% | of soluble organic builders/cobuilders selected from C10- |
| | C18 fatty acids, di- and tricarboxylic acids, hydroxy-di- |
| | and hydroxytricaboxylic acids and polycarboxylic acids |
| 0.05-5% | of an enzyme system containing at least one enzyme |
| | suitable for detergent use and preferably also an enzyme |
| | stabilizing system |
| 0.5-20% | of mono- or diols selected from ethanol, isopropanol, |
| | ethylenglycol, or propylenglycol |
| 0.1-20% | other adjuncts |

water to add up to 100%.

Solid laundry detergents (like e.g. powders, granules or tablets) according to the present invention are composed of:

| | |
|---|---|
| 0.05-20% | of at least one inventive polymer |
| 1-50% | of surfactants |
| 0.1-80% | of builders, cobuilders and/or chelating agents |
| 0-50% | fillers |
| 0-40% | bleach actives |
| 0.1-30% | other adjuncts and/or water |

wherein the sum of the ingredients adds up 100%.

Preferred solid laundry detergents according to the present invention are composed of:

| | |
|---|---|
| 0.2-6% | of at least one inventive polymer |
| 5-30% | of anionic surfactants selected from C₁₀-C₁₅- LAS, |
| | C₁₀-C₁₈ alkylsulfates and C₁₀-C₁₈ alkyl |
| | ethersulfates containing 1-5 ethoxy-units |
| 1.5-7.5% | of non-ionic surfactants selected from C₁₀-C₁₈-alkyl |
| | ethoxylates containing 3-10 ethoxy-units |
| 5-50% | of inorganic builders selected from sodium carbonate, |
| | sodiumbicarbonate, zeolites, soluble silicates, |
| | sodium sulfate |
| 0.5-15% | of cobuilders selected from C₁₀-C₁₈ fatty acids, di- and |
| | tricarboxylic acids, hydroxydi- and hydroxytricarboxylic |
| | acids and polycarboxylic acids |
| 0.1-5% | of an enzyme system containing at least one enzyme |
| | suitable for detergent use and preferably also an |
| | enzyme stabilizing system |
| 0.5-20% | of mono- or diols selected from ethanol, isopropanol, |
| | ethylenglycol, or propylenglycol |
| 0.1-20% | other adjuncts |

water to ad up to 100%

In a preferred embodiment the polymer according to the present invention is used in a manual dish wash detergent.

Liquid manual dish wash detergents according to the present invention are composed of:

| | |
|---|---|
| 0.05-10% | of at least one inventive polymer |
| 1-50% | of surfactants |
| 0.1-50% | of other adjuncts |

water to add up 100%.

Preferred liquid manual dish wash detergents according to the present invention are composed of:

| | |
|---|---|
| 0.2-5% | of at least one inventive polymer |
| 5-40% | of anionic surfactants selected from C₁₀-C₁₅- LAS, C₁₀- |
| | C₁₈ alkyl ethersulfates containing 1-5 ethoxy-units, and |
| | C₁₀-C₁₈ alkylsulfate |
| 2-10% | of Cocamidopropylbetaine |
| 0-10% | of Lauramine oxide |
| 0-2% | of a non-ionic surfactant, preferably a C₁₀-Guerbet |
| | alcohol alkoxylate |
| 0-5% | of an enzyme, preferably Amylase, and preferably also |
| | an enzyme stabilizing system |
| 0.5-20% | of mono- or diols selected from ethanol, isopropanol, |
| | ethylenglycol, or propylenglycol |
| 0.1-20% | other adjuncts |

water to add up to 100%

As the modified alkoxylated polyalkylene imines of the invention are biodegradable, and especially the cleaning formulations typically have a pH of about 7 or higher, and additionally often contain also enzymes—which are included into such cleaning formulations to degrade biodegradable stuff such as grease, proteins, polysaccharides etc. which are present in the stains and dirt which shall be removed by the cleaning compositions—some consideration is needed to be taken to formulate those bio-degradable polymers of the invention. Such formulations suitable are in principle known, and include the formulation in solids—where the enzymes and the polymers can be separated by coatings or adding them in separate particles which are mixed—and liquids and semi-liquids, where the polymers and the enzymes can be separated by formulating them in different compartments, such as different compartments of multi-chamber-pouches or bottles having different chambers, from which the liquids are poured out at the same time in a predefined amount to assure the application of the right amount per individual point of use of each component from each chamber. Such multi-compartment-pouches and bottles etc. are known to a person of skill as well.

The following table shows general cleaning compositions of certain types, which correspond to typical compositions correlating with typical washing conditions as typically employed in various regions and countries of the world. The at least one inventive polymer may be added to such formulation(s) in suitable amounts as outlined herein.

TABLE 1
General formula for laundry detergent compositions
according to the invention:

| | Ranges of Ingredient in |
|---|---|
| Ingredient | Liquid frame formulations |
| Linear alkyl benzene sulphonic acid | 0 to 30% |
| Coco fatty acid | 1 to 12% |
| Fatty alcohol ether sulphate | 0 to 25% |
| NaOH or mono or triethanol amine | Up to pH 7.5 to 9.0 |
| Alcohol ethoxylate | 3 to 10% |
| 1,2-Propylene glycol | 1 to 10% |
| Ethanol | 0 to 4% |
| Sodium citrate | 0 to 8% |
| water | Up to 100% |

TABLE 2
Liquid laundry frame formulations according to the invention:

| | (numbers: % active) | | | | | |
|---|---|---|---|---|---|---|
| active | F1 | F2 | F3 | F4 | F5 | F6 |
| alcohol ethoxylat 7EO | 5.40 | 10.80 | 12.40 | 7.30 | 1.60 | 7.60 |
| Coco fatty acid K12-18 | 2.40 | 3.10 | 3.20 | 3.20 | 3.50 | 6.40 |
| Fatty alcohol ether | 5.40 | 8.80 | 7.10 | 7.10 | 5.40 | 14.00 |
| sulphate | | | | | | |
| Linear alkyl benzene | 5.50 | 0.00 | 14.50 | 15.50 | 10.70 | 0.00 |
| sulphonic acid | | | | | | |
| 1,2 Propandiol | 6.00 | 3.50 | 8.70 | 8.70 | 1.10 | 7.80 |
| Triethanolamine | | | | | | |
| Monoethanolamine | | | 4.00 | 4.30 | 0.30 | |
| NaOH | 2.20 | 1.10 | | | | 1.00 |
| Glycerol | | 0.80 | 3.00 | 2.80 | | |
| Ethanol | 2.00 | | | | 0.38 | 0.39 |
| Na citrate | 3.00 | 2.80 | 3.40 | 2.10 | 7.40 | 5.40 |
| Inventive Polymer (s) | 0-5 | 0-5 | 0-5 | 0-5 | 0-5 | 0-5 |
| (total) | | | | | | |
| Protease | 0-1 | 0-1 | 0-1 | 0-1 | 0-1 | 0-1 |
| Amylase | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 |
| water | to 100 | to 100 | to 100 | to 100 | to 100 | to 100 |

TABLE 2
continued: Liquid laundry frame formulations according to the invention:

| | (numbers: % active) | | | | | | | |
|---|---|---|---|---|---|---|---|---|
| active | F7 | F8 | F9 | F10 | F11 | F12 | F13 | F14 |
| alcohol ethoxylat 7EO | 3.80 | 0.30 | 13.30 | 8.00 | 5.70 | 20.00 | 9.20 | 29.00 |
| Coco fatty acid K12-18 | 2.80 | 3.00 | 1.70 | 1.80 | 2.50 | 5.00 | 8.60 | 10.40 |
| Fatty alcohol ether | 2.80 | 4.50 | 3.90 | 4.10 | | 10.00 | 22.20 | |
| sulphate | | | | | | | | |
| Linear alkyl benzene | 6.30 | 5.43 | 11.45 | 5.90 | 10.10 | 10.00 | 28.00 | 27.00 |
| sulphonic acid | | | | | | | | |
| 1,2 Propandiol | 0.50 | | 2.50 | 0.40 | 6.00 | 10.00 | 7.00 | 7.00 |
| Triethanolamine | | | | 8.10 | | | | |
| Monoethanolamine | 0.40 | 1.80 | | | | | 8.00 | 7.00 |
| NaOH | | | 2.20 | | 3.30 | 1.50 | | |
| Glycerol | | 0.60 | 0.20 | 1.90 | | | 7.00 | 10.00 |
| Ethanol | | | 1.84 | | | | | |
| Na citrate | 4.60 | 3.30 | 3.30 | 1.40 | | 1.50 | | |
| Inventive Polymer (s) | 0-5 | 0-5 | 0-5 | 0-5 | 0-5 | 0-5 | 0-5 | 0-5 |
| (total) | | | | | | | | |
| Protease | 0-1 | 0-1 | 0-1 | 0-1 | 0-1 | 0-3 | 0-3 | 0-3 |
| Amylase | 0-0.5 | 0-0.5 | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 | 0-0.3 | 0-0.3 |
| water | to 100 | to 100 | to 100 | to 100 | to 100 | to 100 | to 100 | to 100 |

TABLE 3
Laundry powder frame formulations according to the invention:

| | Bleach free Powder | | | | | |
|---|---|---|---|---|---|---|
| Alcohol ethoxylate 7EO | 0.6 | 0 | 1 | 0 | 0 | 5.2 |
| Coco fatty acid K12-18 | 1.2 | 0 | 0 | 0 | 0 | 0 |
| Fatty alcohol ether sulphate | 1.5 | 0 | 0 | 0 | 0 | 6 |
| Linear alkyl benzene | 12.1 | 11.2 | 13.6 | 21.9 | 18.7 | 12.7 |
| sulphonic | | | | | | |
| acid | | | | | | |
| Bleach activator | 0 | 0 | 0 | 0 | 0 | 0 |
| Percarbonate | 0 | 0 | 0 | 0 | 0 | 0 |
| AcetateNa | 0 | 0 | 0 | 0.1 | 0 | 0.1 |
| CitrateNa | 0 | 0 | 0 | 0 | 0 | 14 |
| Na Silicate | 27.9 | 5.8 | 6.6 | 2 | 15 | 20.3 |
| Na Carbonate | 17.2 | 35 | 37.3 | 30.1 | 37 | 1 |
| Na Phospahte | 0 | 0 | 0 | 14 | 0.3 | 0 |
| Na Hydrogencarbonate | 0.7 | 0.9 | 0.5 | 2.7 | 0.4 | 10.5 |
| Zeolite4A | 4.2 | 0.1 | 5.1 | 10.2 | 1.8 | 11.6 |
| HEDP | 0 | 0 | 0 | 0 | 0 | 0.13 |
| MGDA | 0 | 1.1 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 30.8 | 1.3 | 33 | 11 | 22 | 3 |
| Na Chloride | 0.2 | 43 | 0.1 | 0 | 0.1 | 0.1 |
| optical brightener | 0.02 | 0 | | 0.1 | 0.06 | |
| Inventive Polymer(s) (total) | 1 | 0 | 0.2 | 2 | 0.5 | 3 |

TABLE 3
continued: Laundry powder frame formulations
according to the invention:

| | Bleach containing Powder | | | | | |
|---|---|---|---|---|---|---|
| Alcohol ethoxylate 7EO | 1.2 | 5 | 4 | 0.5 | 0.5 | 0 |
| Coco fatty acid K12-18 | 0 | 0 | 0 | 0.3 | 0 | 0.6 |
| Fatty alcohol ether sulphate | 0 | 3.9 | 4.4 | 1.6 | 0 | 0 |
| Linear alkyl benzene | 7.6 | 12.1 | 11.5 | 12.2 | 6.5 | 10.4 |
| sulphonic | | | | | | |
| acid | | | | | | |
| Bleach activator | 0.2 | 9.5 | 9.5 | 0.5 | 0.8 | 2.2 |
| Percarbonate | 3.6 | 19.4 | 16.6 | 2.2 | 11.5 | 5.8 |
| AcetateNa | 0 | 6.7 | 7.1 | 0.3 | 1 | 0.7 |
| CitrateNa | 0 | 1.6 | 8.2 | 0.3 | 0.9 | 1.7 |
| Na Silicate | 3.6 | 11.3 | 16.4 | 10.2 | 9.1 | 16.5 |
| Na Carbonate | 21.6 | 8.7 | 1.4 | 8 | 22.9 | 14.8 |
| Na Phospahte | 0 | 0 | 0 | 0 | 0 | 0 |
| Na Hydrogencarbonate | 0.2 | 2.8 | 1.6 | 0.8 | 0.5 | 0.5 |
| Zeolite4A | 1.6 | 1.4 | 2.4 | 1.6 | 1.8 | 2.3 |
| HEDP | 0 | 0.27 | 0.16 | 0 | 0 | 0.17 |
| MGDA | 0 | 0 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 51 | 4 | 6 | 57 | 38 | 37 |
| Na Chloride | 1 | 1 | 0.5 | 1.2 | 0.2 | 1 |
| optical brightener | | 0.29 | 0.1 | 0.23 | 0.13 | 0.19 |
| Inventive Polymer(s) (total) | 2.2 | 9.2 | 2.2 | 0.7 | | 0.4 |

TABLE 4
Liquid manual dish wash frame formulations according to the invention:

| Ingredients | MDW.1 | MDW.2 | MDW.3 | MDW.4 | MDW.5 | MDW.6 | MDW.7 | MDW.8 |
|---|---|---|---|---|---|---|---|---|
| Linear C₁₂-C₁₄-alkyl- | 8 | 0 | 6 | 0 | 6 | 0 | 6 | 0 |
| benzenesulfonic acid | | | | | | | | |
| C₁₂-C₁₄-fatty alcohol × | 8 | 16 | 6 | 12 | 6 | 12 | 6 | 12 |
| 2 EO sulfate | | | | | | | | |
| Cocamidopropyl | 0 | 0 | 4 | 4 | 0 | 0 | 2 | 2 |
| betaine | | | | | | | | |
| Lauramine oxide | 0 | 0 | 0 | 0 | 4 | 4 | 2 | 2 |
| 2-Propylheptanol × | 0.5 | 0.5 | 0.5 | 0.5 | 0.5 | 0.5 | 0.5 | 0.5 |
| 4 EO | | | | | | | | |
| Inventive | 1 | 1 | 1 | 1 | 1 | 1 | 1 | 1 |
| Polymer (s) (total) | | | | | | | | |
| Ethanol | 2 | 2 | 2 | 2 | 2 | 2 | 2 | 2 |
| 2-Phenoxyethanol | 1 | 1 | 1 | 1 | 1 | 1 | 1 | 1 |
| (preservative) | | | | | | | | |
| Sodium chloride | 1 | 1 | 1 | 1 | 1 | 1 | 1 | 1 |
| Demin. water | add 100 | add 100 | add 100 | add 100 | add 100 | add 100 | add 100 | add 100 |
| Sodium hydroxide | add pH 8 | add pH 8 | add pH 8 | add pH 8 | add pH 8 | add pH 8 | add pH 8 | add pH 8 |

The following examples shall further illustrate the present invention without restricting the scope of the invention.

The amount and type of oligoalkylene imines or oligoamines substituted with residues such as, for example, those according to formula (IIa) and/or optionally the presence of hydrogen can be determined by identification of primary, secondary and tertiary amino groups in ¹³C-NMR, as described for polyethylene imines in Lukovkin G. M., Pshezhetsky V. S., Murtazaeva G. A.: Europ. Polymer Journal 1973, 9, 559-565 and St. Pierre T., Geckle M.: ACS Polym. Prep. 1981, 22, 128-129, or by determination of the primary, secondary and tertiary amino number, according to DIN 16945.

¹³C-NMR spectra are recorded in CDCl₃ with a Bruker AV-401 instrument at room temperature. ¹H-NMR spectra are recorded in CDCl₃ or CD₃OD with a Bruker AV-401 instrument at room temperature.

Saponification values are measured according to DIN EN ISO 3657:2013.

The specific embodiments as described throughout this disclosure are encompassed by the present invention as part of this invention; the various further options being disclosed in this present specification as “optional”, “preferred”, “more preferred”, “even more preferred” or “most preferred” (or “preferably” etc.) options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently unless such independent selection is not possible by virtue of the nature of that feature or if such independent selection is explicitly excluded), with each and any and all such possible combinations being included as part of this invention as individual embodiments.

### SYNTHESIS EXAMPLES

### 1) Synthesis of Compounds According to the Present Invention

### 1.1) Oligoamines

Tripropylene tetramine (TPTA) (Mw: 188.31 g/mol) is commercially available from BASF SE, Ludwigshafen, Germany;

Triethylene tetramine (TETA) (Mw: 146.24 g/mol) is commercially available from Huntsman Chemical Corp., Salt Lake City, USA.

### 1.2) Synthesis of the Inventive and Comparative Polymers

### Inventive Example 1

Synthesis of Modified Ethoxylated Tripropylene Tetramine [“mod-ethoxy-TPTA”] (P.1)

### Step 1a (TPTA+0.8 EO/NH)

A 2L autoclave was charged with 110 g of TPTA and 10 g water. The reactor was purged three times with nitrogen and heated to 100° C. 20.5 g ethylene oxide was added within 6 hours. To complete the reaction, the reaction mixture was allowed to post-react for 3 hours at 100° C. Volatile compounds were subsequently removed in vacuo. A viscous yellow oil (127.8 g) was obtained.

### Step 1b (TPTA+0.8 EO/NH+19.2 EO/NH)

105 g of the previously obtained product were filled into a steel pressure reactor and 2.8 g of potassium methoxide (32.5 wt.-% solution) were added. Water and methanol were removed under reduced pressure at 90° C. The reactor was purged with nitrogen to remove air and a nitrogen pressure of 1 bar was set. The reactor was heated to 120° C. and 397 g of ethylene oxide were dosed into the reactor within 10 hours. The mixture was allowed to post react for 3 hours. Volatile compounds were removed under vacuum and 498 g of the ethoxylated intermediate (I1.1) were obtained as a dark yellow viscous oil.

### Step 2 (TPTA+20 EO/NH+3 CL/NH)

200 g of the previously obtained intermediate (I1.1) were melted in the microwave at 50° C. and then added to a 500 mL four-neck round bottom flask equipped with a N2 inlet, a thermometer, a stirrer and a distillation bridge. 118 g of ε-Caprolactone were slowly added via a dropping funnel to the reaction mixture under stirring and nitrogen atmosphere. At the end of the feed, 1.6 g of tin(II) 2-ethylhexanoate (1 wt % in toluene) was added via a disposal syringe. The reaction mixture was then heated to 150° C. and was stirred for 24 hours. 300 g of the product (P.1) were obtained as yellow wax.

### Inventive Example 2

Synthesis of Modified Ethoxylated Triethylene Tetramine [“mod-ethoxy-TETA”] (P.2)

### Step 1a (TETA+0.8 EO/NH)

A 2L autoclave was charged with 130 g of TETA and 13 g water. The reactor was purged three times with nitrogen and heated to 100° C. 31.3 g ethylene oxide was added within 6 hours. To complete the reaction, the reaction mixture was allowed to post-react for 3 hours at 100° C. Volatile compounds were subsequently removed in vacuo. A viscous yellow oil (159 g) was obtained.

### Step 1b (TETA+0.8 EO/NH+19.2 EO/NH)

125 g of the previously obtained product were filled into a steel pressure reactor and 4.2 g of potassium methoxide (32.5 wt.-% solution) were added. Water and methanol were removed under reduced pressure at 80° C. The reactor was purged with nitrogen to remove air and a nitrogen pressure of 1 bar was set. The reactor was heated to 120° C. and 580 g of ethylene oxide were dosed into the reactor within 10 hours. The mixture was allowed to post react for 3 hours. Volatile compounds were removed under vacuum and 697 g of the ethoxylated intermediate (I1.2) were obtained as dark yellow viscous oil.

### Step 2 (TETA+20 EO/NH+3 CL/NH)

178 g of the previously obtained intermediate (I1.2) were melted in the microwave at 50° C. and then added to a 500 mL four-neck round bottom flask equipped with a N2 inlet, a thermometer, a stirrer and a distillation bridge. 81.6 g of ε-Caprolactone were slowly added via a dropping funnel to the reaction mixture under stirring and nitrogen atmosphere. At the end of the feed, 1.3 g of tin(II) 2-ethylhexanoate (1 wt % in toluene) was added via a disposal syringe. The reaction mixture was then heated to 150° C. and was stirred for 24 hours. 235 g of the product (P.2) were obtained as a yellow wax.

### Comparative Example 1

### Synthesis of Ethoxylated and Propoxylated Polyethylene Imine (PEI) (CP.1)

Polyethylene imine (Mw 600 g/mol), ethoxylated and propoxylated (PEI 600+24 EO/NH+16 PO/NH)

Synthesis was performed as described in EP 2209837 B1, example 1.

### 3 Application Experiments

### Primary Cleaning Performance on Oily/Fatty Stains

To determine the primary detergency, the cleaning performance on 16 different oily/fatty stains on cotton, polycotton and polyester fabrics (CFT, Vlaardingen, The Netherlands) was measured by determining the color difference (delta E) between the stains after wash and the unsoiled white fabric using a reflectometer (Datacolor SF600 plus). Each experiment containing the 16 different circular oily/fatty stains (Lipstick, Make-Up, Beef Fat, Frying Fat, Burnt Butter, Palm Oil, Sebum BEY, Sebum Tefo, Collar Stain; All on different fabrics) was repeated 6 times, and the obtained data was used to calculate the average delta E value.

By using these delta E values, the so-called “standardized cleaning performance” (delta delta E) has been calculated for each individual stain. The “standardized cleaning performance” (delta delta E) is the difference of the performance of the laundry detergent including the inventive or comparative polymer, respectively, vs. the laundry detergent w/o any inventive or comparative polymer, respectively.

Table 5 shows the composition of the laundry detergent, Table 6 shows the washing test conditions and Table 7 summarizes the obtained standardized cleaning performance. The standardized cleaning performance shown in Table 7 is the sum of the standardized cleaning performance of all 16 stains. The bigger the sum of the delta E value, the bigger the positive contribution of the inventive or comparative polymer, respectively, on the cleaning performance.

TABLE 5
Composition of the liquid laundry detergent.

| Ingredients | LLD.1 * |
|---|---|
| Linear C₁₂C₁₄-alkylbenzenesulfonic acid | 5.50 |
| C₁₂-fatty alcohol × 2 EO sulfate | 5.40 |
| C₁₂C₁₅-fatty alcohol × 7 EO | 5.40 |
| Coconut C12-C18 fatty acid | 2.40 |
| Sodium hydroxide | 2.20 |
| 1,2-Propylene glycol | 6.00 |
| Ethanol | 2.00 |
| Sodium citrate | 3.00 |
| Demin. water | add 100 |
| pH value | 8.5 |

* All data are wt.-% active ingredient, independent of the respective product form.

TABLE 6
Washing conditions for evaluation of primary
cleaning performance on oily/fatty stains.
Washing conditions

| Device | Launder-O-Meter from SDL Atlas, | |
|---|---|---|
| | Rock Hill, USA | |
| Washing liquor | 250 | mL |
| Washing time | 60 | minutes |
| Washing temperature | 30° | C. |
| Detergent concentration | 3.0 | g/L |
| Water hardness | 2.5 | mmol/L (4:1:8) (14° dH) |
| (Ca:Mg:HCO3) | | |

| | |
|---|---|
| Fabric to liquor ratio | 1:10 |
| Polymer (inventive or | 2.83% by weight (vs. liquid laundry |
| comparative) | detergent) of the polymer, 100% active |
| | ingredient |
| Test fabric * | 16 different circular oily/fatty stains |
| | (KC-H122, KC-H176, KC-H015, |
| | KC-H187, PC-H082, PC-H212, |
| | PC-H210, PC-H252, P-H122, P-H129, |
| | P-H015, P-H187, P-H082, P-H212, |
| | P-H210, P-H252) (CFT, Vlaardingen, |
| | The Netherlands) |
| Ballast fabric | Polyester and cotton ballast, to yield |
| | a 1:1 ratio of polyester/cotton fabric |
| | per experiment |

* After the washing experiment, the test fabrics were rinsed with 14° dH water (2 times), followed by drying at ambient room temperature overnight, prior to the measurement with the reflectometer.

TABLE 7
Results from washing tests (primary cleaning
performance on oily/fatty stains).

| | | Concentration | Standardized cleaning |
|---|---|---|---|
| | | of polymeric | performance |
| Detergent | Example | additive * | (sum delta delta E) |
| LLD.1 | P.1 | 2.83 wt.-% | 32.6 |
| LLD.1 | P.2 | 2.83 wt.-% | 27.4 |
| LLD.1 | I1.1 | 2.83 wt.-% | 2.3 |
| LLD.1 | CP.1 | 2.83 wt.-% | 106.9 |

* All data are wt.-% active ingredient, independent of the respective product form.

### Test Results:

The error of the measurement is +/−10 delta delta E units. Therefore any value >10 (sum delta delta E) means that the respective polymer exhibits a directional and visible contribution to the overall cleaning performance of the respective detergent formulation; Any value >20 (sum delta delta E) means that the respective polymer exhibits even a significant contribution to the overall cleaning performance, i.e. the respective polymer leads to a significant improvement of the formulation.

### Biodegradation Data:

Biodegradation in wastewater was tested in triplicate using the OECD 301F manometric respirometry method. OECD 301F is an aerobic test that measures biodegradation of a sample by measuring the consumption of oxygen. To a measured volume of medium, 100 mg/L test substance, which is the nominal sole source of carbon is added along with the inoculum (30 mg/L, aerated sludge taken from Mannheim waste water treatment plant). This is stirred in a closed flask at a constant temperature (20° C. or 25° C.) for 28 days. The consumption of oxygen is determined by measuring the change in pressure in the apparatus using an OxiTop® C (Xylem 35 Analytics Germany Sales GmbH & Co KG). Evolved carbon dioxide is absorbed in a solution of sodium hydroxide. Nitrification inhibitors are added to the flask to prevent usage of oxygen due to nitrification. The amount of oxygen taken up by the microbial population during biodegradation of the test substance (corrected for uptake by blank inoculum, run in parallel) is expressed as a percentage of ThOD (Theoritical oxygen demand, which is measured by the elemental analysis of the compound). A positive control Glucose/Glucosamine is run along with the test samples for each cabinet.

TABLE 8
Biodeg tests

| Example | Biodeg data |
|---|---|
| P.1 | ++ |
| P.2 | ++ |
| I1.1 | ∘ |
| CP.1 | ∘ |

### Test Results

Only the inventive polymers P.1 and P.2 exhibit significant biodegradation properties (>10%) in the OECD 301F test after 28 days. Therefore, only the inventive material (polymers P.1 and P.2) show a good combination of cleaning performance (i.e. visible improvement of the formulation) and biodegradation.
o=<10%
+=10-20%
++=20-50%
+++=>50%

1.-15. (canceled)

16. A modified alkoxylated oligoalkylene imine or modified alkoxylated oligoamine obtainable by a process comprising the steps a) to b) as follows:
a) reaction of i) at least one oligoalkylene imine with a weight average molecular weight (Mw) lower than 400 g/mol or at least one oligoamine with a weight average molecular weight (Mw) lower than 400 g/mol with ii) at least one alkylene oxide (AO), wherein at least 10 mol of alkylene oxide (AO) is employed per mol of NH-functionality of oligoalkylene imine or of oligoamine, in order to obtain an intermediate (I),
b) reaction of the intermediate (I) with at least one lactone (LA) and/or at least one hydrox carbon acid (HA), wherein at least 1.0 mol of lacton (LA) and/or hydroxy carbon acid (HA) is employed per mol of NH-functionality of oligoalkylene imine or of oligoamine (as employed in step a)), in order to obtain the modified alkoxylated oligoalkylene imine or the modified alkoxylated oligoamine.

17. The modified alkoxylated oligoalkylene imine or modified alkoxylated oligoamine according to claim 16, wherein the at least one oligoalkylene imine with a weight average molecular weight (Mw) lower than 400 g/mol or the at least one oligoamine with a weight average molecular weight (Mw) lower than 400 g/mol as employed in step a) is defined according to general formula (I) 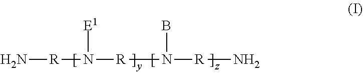
in which the variables are each defined as follows:
R represents identical or different,
i) linear or branched C₂-C₁₂-alkylene radicals or
ii) an etheralkyl unit of the following formula (III): 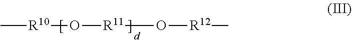
In which the variables are each defined as follows:
R¹⁰, R¹¹, R¹² represent identical or different, linear or branched C₂-C₆-alkylene radicals and
d is an integer having a value in the range of 0 to 6 or
iii) C₅-C₁₀ cycloalkylene radicals optionally substituted with at least one C₁-C₃ alkyl;
y is an integer having a value in the range of 0 to 8;
E¹ represents identical or different
i) hydrogen or
ii) hydrogen and/or C₁-C₁₈-alkyl;
B represents a continuation of the oligoalkylene imine by branching;
z is an integer having a value in the range of 0 to 8;
the sum of y+z is an integer having a value in the range of 0 to 8;
R represents identical or different,
i) linear or branched C₂-C₁₂-alkylene radicals, or
ii) C₅-C₁₀-cycloalkylene radicals optionally substituted with at least one C₁-C₃-alkyl;
E¹ represents H and/or methyl.

18. The modified alkoxylated oligoalkylene imine or modified alkoxylated oligoamine according to claim 16 containing at least one residue according to general formula (IIa) 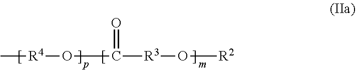
in which the variables are each defined as follows:
R² is hydrogen or selected from the group of unsubstituted or at least monosubstituted C₁-C₂₂-alkyl, C₇-C₂₂-aralkyl, —(CO)—C₁-C₂₂-alkyl, —(CO)—C₂-C₃₀-alkenyl and/or —(CO)—C₇-C₂₂-aralkyl and the substituents are selected from —COOH or a salt thereof;
R³ represents linear or branched C₁-C₂₂-alkylene radicals;
R⁴ represents C₂-C₂₂-(1,2-alkylene) radicals;
m is an integer having a value of at least 1 to 20;
p is an integer having a value of at least 10 to 100;
the variables within general formula (IIa) are defined as follows:
R² represents hydrogen, C₁-C₄-alkyl, —(CO)—C₁-C₄-alkyl; and/or
R³ represents linear or branched C₂-C₁₀-alkylene radicals; and/or
R⁴ represents 1,2-ethylene and/or 1,2-propylene; and/or
m is an integer having a value in the range of 1 to 15; and/or
p is an integer having a value in the range of 10 to 50.

19. The modified alkoxylated oligoalkylene imine or modified alkoxylated oligoamine according to claim 16 containing at least one residue according to general formula (IIb) 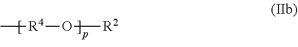
in which the variables are defined as follows:
R² is hydrogen or selected from the group of unsubstituted or at least monosubstituted C₁-C₂₂-alkyl, C₇-C₂₂-aralkyl, —(CO)—C₁-C₂₂-alkyl, —(CO)—C₂-C₃₀-alkenyl and/or —(CO)—C₇-C₂₂-aralkyl and the substituents are selected from —COOH or a salt thereof;
R⁴ represents C₂-C₂₂-(1,2-alkylene) radicals;
p is an integer having a value of at least 10 to 100;
the variables within general formula (IIb) are defined as follows:
R² represents hydrogen, C₁-C₄-alkyl, —(CO)—C₁-C₄-alkyl; and/or
R⁴ represents 1,2-ethylene and/or 1,2-propylene; and/or
p is an integer having a value in the range of 10 to 50.

20. The modified alkoxylated oligoalkylene imine or modified alkoxylated oligoamine according to claim 16, wherein
i) step a) is carried out in the absence of water and/or in the presence of a catalyst, and/or
ii) step a) is carried out as a two-step reaction, wherein the first step is carried out in the presence of water and the second step is carried out without any water, but in the presence of a catalyst, and/or
iii) more than 50 wt % of the alkylene oxide (AO) employed in step a) is based on ethylene oxide, and/or
iv) the weight average molecular weight (Mw) of the oligoalkylene imine or of the oligoamine employed in step a) lies in the range of 60 to 390 g/mol; or
v) the weight average molecular weight (Mw) of the oligoalkylene imine or the oligoamine employed in step a) lies in the range of 100 to 200 g/mol; or
vi) the weight average molecular weight (Mw) of the oligoalkylene imine or the oligoamine employed in step a) lies in the range of 250 to 350 g/mol.

21. The modified alkoxylated oligoalkylene imine according to claim 17, wherein the variables are each defined as follows:
R is ethylene and/or propylene;
the sum of y+z is an integer having a value in the range of 1 to 8.

22. The modified alkoxylated oligoalkylene imine or modified alkoxylated oligoamine according to claim 17, wherein
y is an integer having a value in the range of 0 to 8;
z is 0;
E¹ represents H and/or methyl;
R represents identical or different, linear or branched C₂-C₁₂-alkylene radicals or an etheralkyl unit according to formula (III), wherein
d is from 0 to 6, and
R¹⁰, R¹¹, R¹² are independently selected from linear or branched C₃ to C₄ alkylene radicals;
R represents identical or different, linear C₂ and/or C₃-alkylene radicals.

23. The modified alkoxylated oligoalkylene imine or modified alkoxylated oligoamine according to claim 16, wherein up to 100% of the nitrogen atoms present in the modified alkoxylated oligoalkylene imine or modified alkoxylated oligoamine are further quaternized.

24. The modified alkoxylated oligoalkylene imine or modified alkoxylated oligoamine according to claim 16, wherein
i) in step a) the alkylene oxide (AO) is at least one C₂-C₂₂-epoxide,
ii) in step b) the lactone (LA) is caprolactone or lactide, and/or
iii) in step b) the hydroxy carbon acid (HA) is lactic acid or glycolic acid.

25. The modified alkoxylated oligoalkylene imine or modified alkoxylated oligoamine according to claim 16, wherein
i) in step a) 10 to 100 mol of alkylene oxide (AO) is employed per mol of NH-functionality of oligoalkylene imine or of oligoamine, and/or
ii) in step b) 1.0 to 10 mol of hydroxy carbon acid (HA) is employed per mol of NH-functionality of oligoalkylene imine or of oligoamine (as employed in step a)).

26. The modified alkoxylated oligoalkylene imine or modified alkoxylated oligoamine according to claim 16, wherein
i) in step a) the alkylene oxide (AO) is ethylene oxide.
ii) in step a) 10 to 100 mol of alkylene oxide (AO) is employed per mol of NH-functionality of oligoalkylene imine or of oligoamine, and/or
iii) in step b) the lactone is caprolactone, and 1.0 to 10 mol of caprolactone is employed per mol of NH-functionality of oligoalkylene imine or of oligoamine (as employed in step a)).

27. Use of the modified alkoxylated oligoalkylene imine or modified alkoxylated oligoamine according to claim 16 in cleaning compositions, in fabric and home care products, in cosmetic formulations, as crude oil emulsion breaker, in pigment dispersions for ink jet inks, in formulations for electro plating, in cementitious compositions and/or as dispersant for agrochemical formulations.

28. The use according to claim 27 in cleaning compositions and/or in fabric and home care products for:
i) removal of oily/fatty stains, and/or
ii) clay removal, and/or
iii) soil removal of particulate stains, and/or
iv) dispersion and/or emulsification of soils, and/or
v) modification of treated surface to improve removal upon later re-soiling, and/or
vi) whiteness improvement and/or
vii) wherein at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, is present—additionally for removal of oily/fatty stains, food stain removal and/or removal of complex stains.

29. A cleaning composition, fabric and home care product, industrial and institutional cleaning product, cosmetic formulation, crude oil emulsion breaker, pigment dispersion for ink jet inks, formulation for electro plating, cementitious composition and/or dispersant for agrochemical formulations, comprising at least one modified alkoxylated oligoalkylene imine or modified alkoxylated oligoamine according to claim 16.

30. A method utilizing the cleaning composition according to claim 29 for:
i) improved removal of oily/fatty stains, and/or
ii) clay removal, and/or
iii) soil removal of particulate stains, and/or
iv) dispersion and/or emulsification of soils, and/or
v) modification of treated surface to improve removal upon later re-soiling, and/or
vi) whiteness improvement and/or
vii) wherein the at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, is present—additionally for of removal of oily/fatty stains, food stain removal and/or removal of complex stains.
